(19) United States
(12) Patent Application Publication
(10) Pub. No.: US 2009/0111569 A1
(43) Pub. Date: Apr. 30, 2009

(54) Gaming Machine

(75) Inventor: Kazumasa YOSHIZAWA, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE CORP., Tokyo (JP)

(21) Appl. No.: 12/261,301

(22) Filed: Oct. 30, 2008

(30) Foreign Application Priority Data
Oct. 31, 2007 (JP) 2007-283442

(51) Int. Cl. A63F 13/00

(52) U.S. Cl. 463/20

(57) ABSTRACT

A slot machine variably displays symbols and stops symbols in a variable display portion using composite reel bands. Each of the composite reel bands is generated by combining a symbol reel band with a background reel band. The background reel band is configured to include partial background images that are a part of a special background image. If one special background image is displayed by a background image of composite symbols stopped in the variable display portion as a result of variable display and stop of symbols based on the composite reel bands, the slot machine awards a bonus game to a player.

### CROSS-REFERENCE TO RELATED APPLICATIONS

This application is based upon and claims a priority from the prior Japanese Patent Application No. 2007-283442 filed on Oct. 31, 2007, the entire contents of which are incorporated herein by reference.

### BACKGROUND

1. Field

The present invention relates to a gaming machine variably displaying symbols and stopping symbols. More specifically, the present invention relates to a gaming machine awarding a special prize to a player according to a condition of arrangement of stopped symbols.

2. Description of the Related Art

There is conventionally known a gaming machine including a symbol display portion that includes a plurality of symbol display areas and configured to award a special prize (winning of JP (Jack Pot) or shift to a bonus game) to a player if the player satisfies a predetermined condition. A gaming machine of this type is disclosed in, for example, U.S. Pat. No. 6,517,433. In case of the gaming machine disclosed in the U.S. Pat. No. 6,517,433, if a specific symbol or a specific combination of symbols appears on a payline bet gaming values, a bonus game is executed.

The predetermined condition for the gaming machine is not limited to that using the concept of the payline as disclosed in the U.S. Pat. No. 6,517,433. That is, various conditions are set for conventional gaming machines. For example, in case of a certain conventional gaming machine, if a predetermined number or more of specific kinds of symbols are stopped in the symbol display potion, the special prize is awarded to the player.

As described above, in the conventional gaming machines, the special prize is awarded to the player if the specific combination of symbols on the payline activated or the predetermined number or more of specific kinds of symbols are stopped. That is, in the conventional gaming machine, it is an important role for stopping symbols in the symbol display portion so as to notify the player whether or not the player can obtain a prize (or particularly a special prize).

Nevertheless, the conventional gaming machine only simply variably displays symbols and stops symbols. That is to say, the conventional gaming machine is incapable of sufficiently notifying the player whether to award a prize (special prize) to the player or not. Accordingly, a player familiar with the gaming machine can grasp whether or not he/she has won the prize (special prize). However, a player who plays a game using the slot machine for the first time cannot promptly grasp whether or not he/she has won the prize (special prize).

Particularly, if a player uses a slot machine for which a condition that a predetermined number or more of specific kinds of symbols are stopped is set as a condition of awarding a special prize to the player, the player is forced to calculate the number of specific kinds of symbols among a plurality of symbols stopped. If the player is to grasp whether or not the player can obtain a special prize, such a gaming machine disadvantageously imposes excessive burden on the player. Further, in the gaming machine, it is difficult for the player to grasp whether or not the player can obtain a special award. As a result, the slot machine discourages the player using the slot machine for the first time from playing games.

The present invention has been achieved to solve the above problems. It is an object of the present invention to provide a gaming machine awarding a special prize to a player based on a predetermined condition, enabling the player to easily grasp whether or not the player can obtain a special prize, and capable of enhancing the great interest of the player.

### SUMMARY

Therefore, in order to achieve the object, according to a first aspect of the present invention, there is provided a gaming machine comprising: a display displaying: a plurality of symbol display areas in each of which plural kinds of symbols are variably displayed and one symbol is stopped; a plurality of reel display portions each of which is associated with a symbol column on which plural kinds of symbols are arranged, and constituted by a symbol display area; and a symbol display portion consisting of the plurality of reel display portions; and a processor executing processes of: (a) a process of combining a background image column on which a background image is arranged, the background image including a split background image obtained by dividing a special background image of a size corresponding to the plural symbol display areas per the symbol display area, with a symbol image column on which plural kinds of symbol images are arranged; (b) a process of generating a composite symbol column on which a plurality of composite symbols, each consisting of a background image and a symbol image, are arranged; (c) a process of accepting a bet of a gaming value; (d) a process of variably displaying the plurality of symbols in the symbol display portion based on the composite symbol column; (e) a process of stopping the plurality of symbols as a result of a game; (f) a process of awarding an normal prize to a player according to number of symbols being stopped in the symbol display portion and having a symbol image of a same kind; and (g) a process of awarding a special prize to the player if one special background image is constructed by a plurality of background images of the respective plurality of composite symbols stopped in the symbol display portion.

According to one aspect of the present invention, a gaming machine variably displays and stops symbols in a symbol display portion configured to include a plurality of reel display portions. The gaming machine awards a normal prize to a player based on the number of symbols of the same kind stopped in the symbol display portion.

The gaming machine variably displays and stops symbols based on a composite symbol column generated by combining a background image column with a symbol image column. The background image column constituting the composite symbol column is constituted by a background image including a split background image. The split background image is constituted by dividing a special background image per symbol display area. The special background image has a size corresponding to a plurality of symbol display areas. Therefore, if stopping symbols based on the composite symbol column, the gaming machine can display one special background image by the background image constituting composite symbols stopped in the symbol display portion. Further, the gaming machine awards a special prize to the player if the special background image is constituted by the background image of the composite symbols stopped in the symbol display portion.

As a result, even a player unfamiliar with the gaming machine can easily and visually grasp whether or not one special background is constituted in the symbol display portion by visually recognizing the symbol display portion. Therefore, according to the gaming machine, the player can easily and promptly grasp presence or absence of the special prize based on the display of one special background image in the symbol display portion.

According to one or more aspects of the present invention, there is provided a gaming machine comprising: a display displaying: a plurality of symbol display areas in each of which plural kinds of symbols are variably displayed and one symbol is stopped; a plurality of reel display portions each of which is associated with a symbol column on which plural kinds of symbols are arranged, and constituted by a symbol display area; and a symbol display portion consisting of the plurality of reel display portions; and a processor executing processes of: (a) a process of combining a background image column on which a background image is arranged, the background image including a split background image obtained by dividing a special background image of a size corresponding to the plural symbol display areas per the symbol display area, with a symbol image column on which plural kinds of symbol images are arranged; (b) a process of generating a composite symbol column on which a plurality of composite symbols, each consisting of a background image and a symbol image, are arranged; (c) a process of identifying a plurality of reel display portions corresponding to the size of the special background image and adjoining one another; (d) a process of associating the plurality of reel display portions which are identified; with a plurality of composite symbol columns each including a split background image corresponding to a different part of the special background image, respectively; (e) a process of allowing the special background image to be displayed in the plurality of reel display portions currently identified; (f) a process of accepting a bet of a gaming value; (g) a process of variably displaying the plurality of symbols in the symbol display portion based on the composite symbol column; (h) a process of stopping the plurality of symbols as a result of a game; (i) a process of awarding an normal prize to a player according to number of symbols being stopped in the symbol display portion and having a symbol image of a same kind; and (j) a process of awarding a special prize to the player if one special background image is constructed by a plurality of background images of the respective plurality of composite symbols stopped in the symbol display portion.

According to another aspect of the present invention, similarly to the gaming machine according to one aspect of the present invention, a gaming machine variably displays and stops symbols in a symbol display portion configured to include a plurality of reel display portions. The gaming machine awards an normal prize to a player according to the number of symbols of the same kind stopped in the symbol display portion.

The gaming machine variably displays and stops symbols based on a composite symbol column. The background image column constituting the composite symbol column is constituted by a background image including a split background image. The split background image is constituted by dividing a special background image per symbol display area. The special background image has a size corresponding to a plurality of symbol display areas.

The gaming machine identifies a plurality of reel display portions that adjoin one another. A total size of the identified plurality of reel display portions corresponds to the size of the special background image. The gaming machine associates each composite symbol column including a split background image corresponding to a different part of the special background image with each of the identified plurality of reel display portions. Therefore, if stopping symbols based on the composite symbol columns, the gaming machine can ensure displaying one special background image in the plurality of reel display portions identified in the symbol display portion. Further, the gaming machine awards a special prize to the player if the special background image is constituted by the background image of the composite symbols stopped in the symbol display portion.

As a result, even a player unfamiliar with the gaming machine can easily and visually grasp whether or not one special background is constituted in the symbol display portion by visually recognizing the symbol display portion. Therefore, according to the gaming machine, the player can easily and promptly grasp presence or absence of the special prize based on the display of one special background image in the symbol display portion.

According to one or more aspects of the present invention, there is provided a gaming machine comprising: a display displaying: a plurality of symbol display areas in each of which plural kinds of symbols are variably displayed and one symbol is stopped; a plurality of reel display portions each of which is associated with a symbol column on which plural kinds of symbols are arranged, and constituted by a symbol display area; and a symbol display portion consisting of the plurality of reel display portions; and a processor executing processes of: (a) a process of combining a background image column on which a background image is arranged, the background image including a split background image obtained by dividing a special background image of a size corresponding to the plural symbol display areas per the symbol display area, with a symbol image column on which plural kinds of symbol images are arranged; (b) a process of generating a composite symbol column on which a plurality of composite symbols, each consisting of a background image and a symbol image, are arranged; (c) a process of identifying a plurality of reel display portions corresponding to the size of the special background image and adjoining one another; (d) a process of associating the plurality of reel display portions which are identified; with a plurality of composite symbol columns each including a split background image corresponding to a different part of the special background image, respectively; (e) a process of allowing the special background image to be displayed in the plurality of reel display portions currently identified; (f) a process of accepting a bet of a gaming value; (g) a process of variably displaying the plurality of symbols in the symbol display portion based on the composite symbol column; (h) a process of stopping the plurality of symbols as a result of a game; (i) a process of awarding an normal prize to a player according to number of symbols being stopped in the symbol display portion and having a symbol image of a same kind; (j) a process of awarding a special prize to the player if one special background image is constructed by a plurality of background images of the respective plurality of composite symbols stopped in the symbol display portion; and (k) a process of changing the special background image used for generating the composite symbol column to another special background image if a predetermined condition is met.

According to another aspect of the present invention, similarly to the gaming machine according to one aspect of the present invention, a gaming machine variably displays and stops symbols in a symbol display portion configured to include a plurality of reel display portions. The gaming machine awards an normal prize to a player according to the number of symbols of the same kind stopped in the symbol display portion.

The gaming machine variably displays and stops symbols based on a composite symbol column. The background image column constituting the composite symbol column is constituted by a background image including a split background image. The split background image is constituted by dividing a special background image per symbol display area. The special background image has a size corresponding to a plurality of symbol display areas.

The gaming machine identifies a plurality of reel display portions that adjoin one another. A total size of the identified plurality of reel display portions corresponds to the size of the special background image. The gaming machine associates each composite symbol column including split background image corresponding to a different parts of the special background image with each of the identified plurality of reel display portions. Therefore, if stopping symbols based on the composite symbol columns, the gaming machine can ensure displaying one special background image in the plurality of reel display portions identified in the symbol display portion. Further, the gaming machine awards a special prize to the player if the special background image is constituted by the background image of the composite symbols stopped in the symbol display portion.

As a result, even a player unfamiliar with the gaming machine can easily and visually grasp whether or not one special background is constituted in the symbol display portion by visually recognizing the symbol display portion. Therefore, according to the gaming machine, the player can easily and promptly grasp presence or absence of the special prize based on the display of one special background image in the symbol display portion.

Moreover, if a predetermined condition is satisfied, the gaming machine changes the special background image used to generate the composite symbol columns to another special background image. The background image constituting the composite symbols thereby changes. Therefore, The gaming machine can change a display style of the symbol display portion. Accordingly, the gaming machine can enhance the interest of the player. Further, if stopping symbols in the symbol display portion based on the composite symbol columns, the gaming machine can display a different special background image in the symbol display portion. As a result, the special background image that can be displayed in the symbol display portion can be changed. Thus, the gaming machine can enhance the interest of the player even when notifying the player of presence or absence of the special prize.

### BRIEF DESCRIPTION OF THE DRAWINGS

The accompanying drawings, which are incorporated in and constitute a part of this specification illustrate embodiments of the invention and, together with the description, serve to explain the objects, advantages and principles of the invention.

FIG. 1A is an explanatory view illustrating a variable display portion upon bonus game trigger with a small special background image;

FIG. 1B is an explanatory view illustrating a variable display portion upon bonus game trigger with a large special background image;

FIG. 2 is a perspective view of a slot machine;

FIG. 3 is an explanatory view illustrating reel display portions of the slot machine;

FIG. 4 is an explanatory view illustrating symbol display areas of the slot machine;

FIG. 5 is a block diagram illustrating an internal constitution of the slot machine;

FIG. 6 is a block diagram illustrating an internal constitution of the sub control board of the slot machine;

FIG. 7 is an explanatory view illustrating symbols constituting a symbol reel band;

FIG. 8 is an explanatory view illustrating an example of a symbol reel band;

FIG. 9A is an explanatory view illustrating a small special background image used for generating composite reel bands;

FIG. 9B is an explanatory view illustrating a large special background image used for generating composite reel bands;

FIG. 10 is an explanatory view illustrating an example of background reel bands based on a small special background image;

FIG. 11 is an explanatory view illustrating an example of background reel bands based on a large special background image;

FIG. 12 is an explanatory view illustrating a variable display portion upon variable display of composite reel bands;

FIG. 13 is an explanatory view illustrating a variable display portion upon stop and display of composite symbols;

FIG. 14 is an explanatory view illustrating a payout table of the slot machine;

FIG. 15 is a flow chart of a main control process program;

FIG. 16 is a flow chart of a main game process program;

FIG. 17 is an explanatory view with respect to the generation of a composite reel based on a symbol reel band and a background reel band;

FIG. 18 is an explanatory view illustrating an example of a table associating code numbers and composite symbols;

FIG. 19 is an explanatory view illustrating an example of a table associating random number values and code numbers;

FIG. 20 is a flow chart of a composite reel band generation process program;

FIG. 21 is an explanatory view with respect to the process contents of a background size determination process;

FIG. 22 is an explanatory view with respect to a small special background image determination table;

FIG. 23 is an explanatory view with respect to a large special background image determination table;

FIG. 24 is an explanatory view with respect to the process contents of a target reel band identification process; and

FIG. 25 is a flow chart of a bonus game process program.

### DETAILED DESCRIPTION

The various aspects summarized previously may be embodied in various forms. The following description shows by way of illustration of various combinations and configurations in which the aspects may be practiced. It is understood that the described aspects and/or embodiments are merely examples, and that other aspects and/or embodiments may be utilized and structural and functional modifications may be made, without departing from the scope of the present disclosure.

It is noted that various connections are set forth between items in the following description. It is noted that these connections in general and, unless specified otherwise, may be direct or indirect and that this specification is not intended to be limiting in this respect.

A gaming machine according to one or more aspects of the invention will be described in detail with reference to the drawings based on an embodiment embodying one or more aspects of the invention. However, it is appreciated that one or more aspects of the present invention may be embodied in distributable (via CD and the like) or downloadable software games, console games, and the like. Aspects of the invention are described by way of hardware elements. However, it is appreciated that these elements may also be software modules that are executable in a computer. The software modules may be stored on a computer readable medium, including but not limited to a USB drive, CD, DVD, computer-readable memory, tape, diskette, floppy disk, and the like. For instance, aspects of the invention may be embodied in a JAVA-based application or the like that runs in a processor or processors. Further, the terms “CPU” and “processor” are inclusive by nature, including at least one of hardware, software, or firmware. These terms may include a portion of a processing unit in a computer (for instance, in multiple core processing units), multiple cores, a functional processor (as running virtually on at least one of processor or server, which may be local or remote). Further, in network-based gaming systems, the processor may include only a local processor, only a remote server, or a combination of a local processor and a remote server.

It is contemplated that one or more aspects of the invention may be implemented as computer executable instructions on a computer readable medium such as a non-volatile memory, a magnetic or optical disc. Further, one or more aspects of the invention may be implemented with a carrier signal in the form of, for instance, an audio-frequency, radio-frequency, or optical carrier wave.

An embodiment in which a gaming machine according to the present invention is applied to a slot machine 1 will be described hereinafter with reference to the drawings.

The slot machine 1 according to the embodiment includes an image display device such as a liquid crystal display. The slot machine 1 executes a game by displaying images of various symbols on the image display device. That is, the slot machine 1 is a so-called video slot machine.

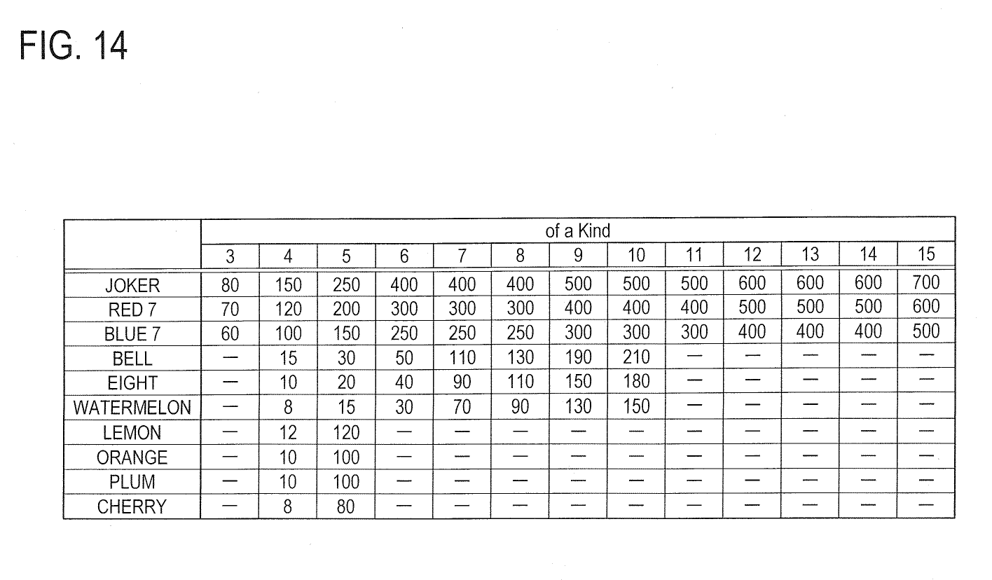

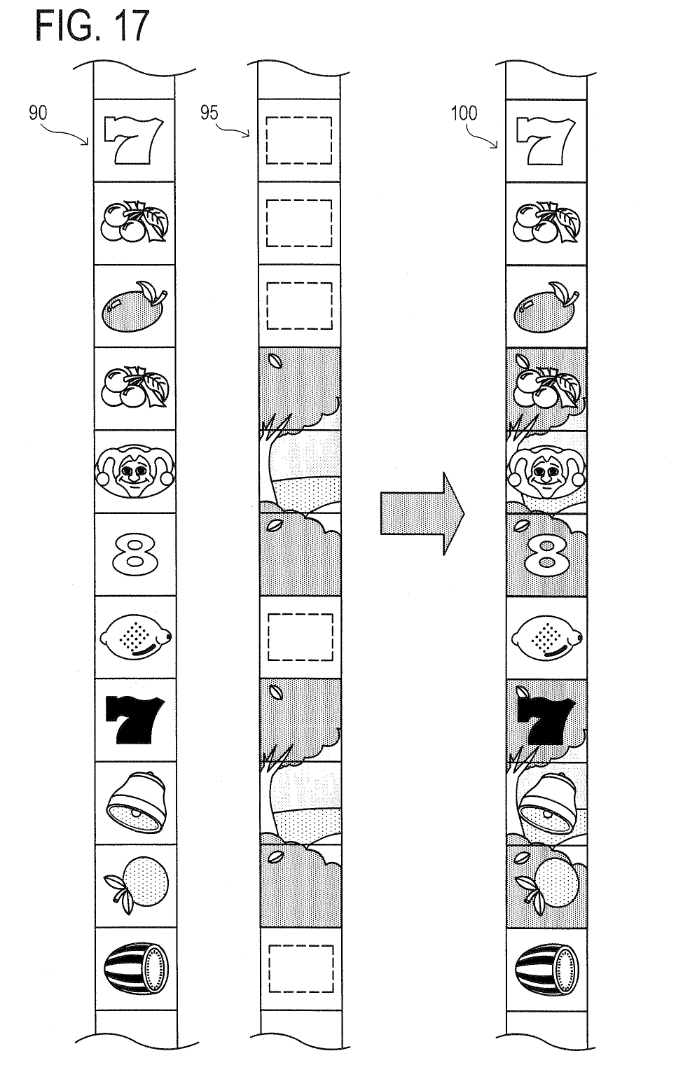

The slot machine 1 according to the embodiment is a so-called all scatter slot machine. The slot machine 1 awards a prize determined based on the number of the same kind of symbols stopped in a variable display portion 3B (refer to FIG. 14). The slot machine 1 variably displays and stops symbols based on a composite reel band 100. The composite reel band 100 is generated by combining a symbol reel band 90 and a background reel band 95 (refer to FIG. 17). The background reel band 95 includes split background images obtained by dividing a special background image (that is, a small special background image 50 or a large special background image 55).

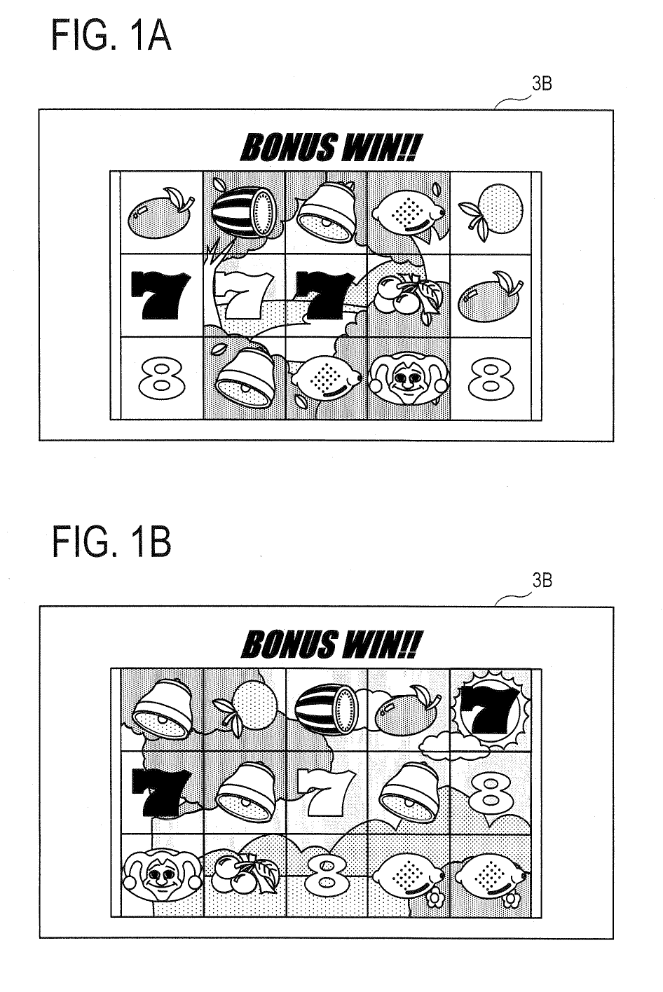

Therefore, by variably displaying and stopping symbols based on the composite reel band 100, the slot machine 1 can display the special background image (that is, the small special background image 50 or the large special background image 55) related to the composite reel band 100 on the variable display portion 3B (refer to FIG. 1A and FIG. 1B). If the special background image is displayed on the variable display portion 3B, the slot machine 1 awards a so-called free game to a player as a bonus game.

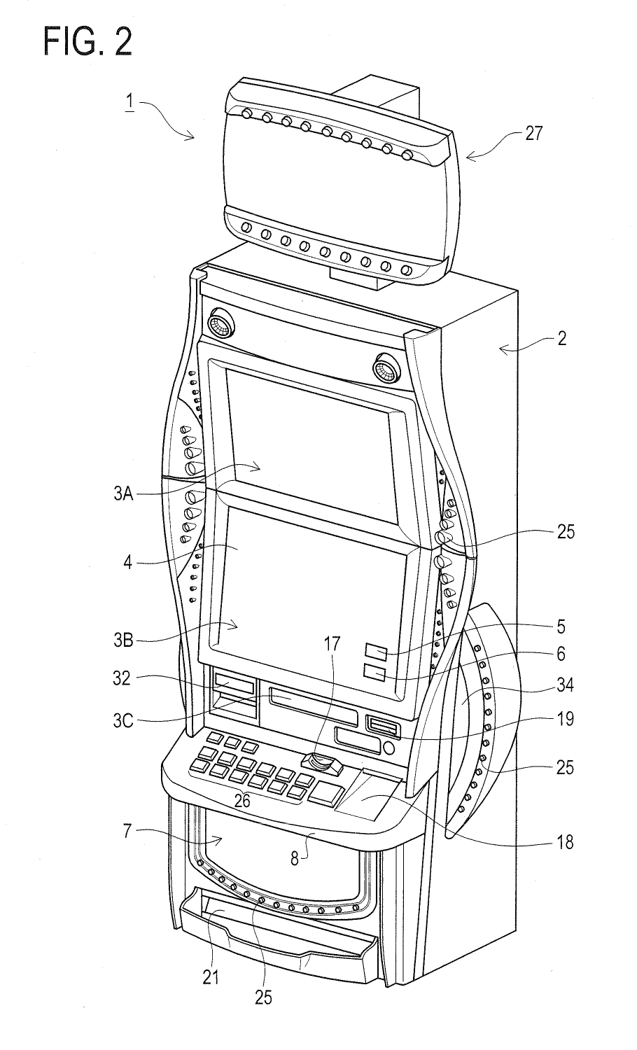

A schematic configuration of the slot machine 1 according to the embodiment will next be described in detail with reference to the drawings. FIG. 2 is an external perspective view of the slot machine 1 according to the embodiment.

The slot machine 1 according to the embodiment is an upright slot machine installed in a game arcade such as a casino. An appearance of the slot machine 1 shown in FIG. 2 is merely an example in the present invention. The present invention is not limited to the slot machine 1 having the external view shown in FIG. 2.

As shown in FIG. 2, the slot machine 1 has a cabinet 2. The cabinet 2 is a storage unit for storing an electric or mechanical components to execute a predetermined game form.

The slot machine 1 includes an upper display portion 3A, the variable display portion 3B, and a lower display portion 3C on the front of the cabinet 2. The upper display portion 3A, the variable display portion 3B, and the lower display portion 3C display various kinds of gaming information.

The upper display portion 3A is constituted of a liquid crystal panel. The upper display portion 3A is arranged in an upper portion of the cabinet 2. The upper display portion 3A displays effect image, a payout table in a game, a game rule, and the like.

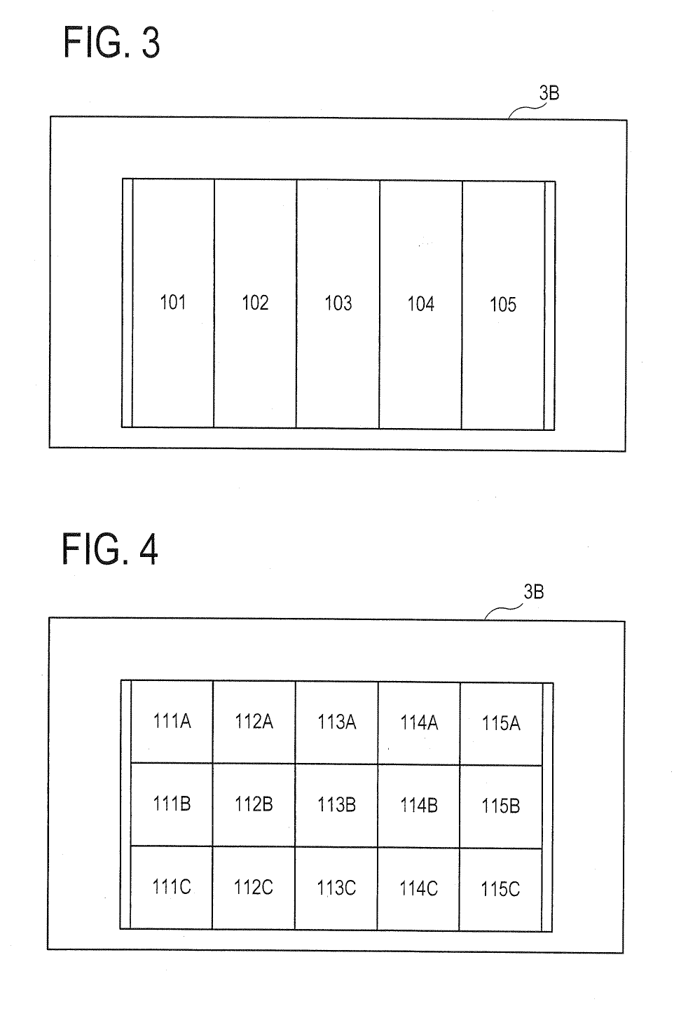

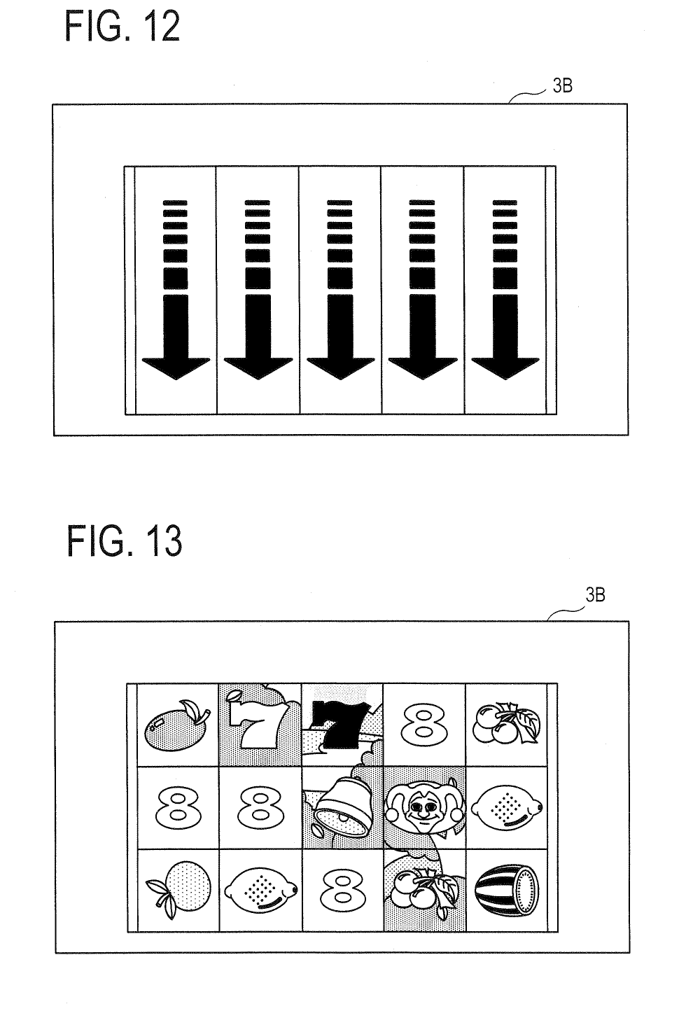

The variable display portion 3B is constituted of a liquid crystal panel. The variable display portion 3B is arranged in a center portion of the cabinet 2. The variable display portion 3B has five reel display portions 101 through 105 (refer to FIG. 3). the composite reel band 100 is variably displayed or stopped on each of the reel display portions 101 through 105. Each of the reel display portions 101 through 105 has three symbol display areas. Specifically, the reel display portions 101 through 105 have symbol display areas 111A through 111C, 112A through 112c, 113A through 113C, 114A through 114C, and 115A through 115C, respectively (refer to FIG. 4). one composite symbol is displayed on each of the symbol display areas 111A through 111C, 112A through 112c, 113A through 113C, 114A through 114C, and 115A through 115C displays (refer to FIGS. 1A, 1B and 13). That is, the variable display portion 3B displays fifteen composite symbols in a matrix of 3×5. The number of reels and the number of display symbols on one reel display portion are variable.

A touch panel 4 is arranged in front of the liquid crystal panel of the variable display portion 3B. A player can input various commands by operating the touch panel 4. A payout amount display portion 5 and a credit amount display portion 6 are provided in a lower right portion of the variable display portion 3B. In this regard, the display positions of the payout amount display portion 5 and the credit amount display portion 6 are arbitrarily determined. Furthermore, a bet amount display portion for displaying a bet amount can be provided in the variable display portion 3B. The payout amount display portion 5 displays a payout amount awarded to the player (that is, a payout amount awarded when a predetermined condition is satisfied in a normal game and an accumulated payout amount which the player obtains during a free game). The credit amount display portion 6 displays a credit amount that the player currently possesses.

The lower display portion 3C is constituted of a liquid crystal panel. The lower display portion 3C is arranged in a lower portion of the cabinet 2. The lower display portion 3C displays the number of points recorded on a card or the points of a game. When the card is not inserted or reading of the card is failed, the lower display portion 3C displays the fact that the card is not inserted or reading of the card is failed.

A card reading portion 19 is arranged around the lower display portion 3C. The card reading portion 19 reads information stored in the card that the player currently possesses.

As described above, the upper display portion 3A, the variable display portion 3B, and the lower display portion 3C according to the embodiment are constituted of the liquid crystal displays, respectively. However, configuration of the upper display portion 3A, the variable display portion 3B, and the lower display portion 3C are not limited to the liquid crystal displays. For example, the display portions may be configured by using CRT displays, plasma displays, LED displays, and other known display devices.

A lower panel 7 is arranged on a lower portion of the lower display portion 3C. The lower panel 7 is constituted by a plastic panel on which pictures of characters related to the slot machine 1, a name of the slot machine 1 and the like are drawn. The lower panel 7 is illuminated by a backlight. The lower panel 7 may also be constituted of a liquid crystal display, a CRT display, a plasma display, an LED display, or another known display device.

An operation table 8 is arranged on a lower portion of the variable display portion 3B. Various operation buttons 26 (such as an exchange button, a payout button, a help button, a BET button, and a start button) are arranged on the operation table 8. A coin insertion portion 17 and a bill insertion portion 18 are also arranged on the operation table 8.

The position to arrange the respective types of operation buttons can be determined arbitrarily. As necessary, one portion of the respective operation buttons may be eliminated or buttons may be newly added or replaced.

A coin payout portion and a coin tray 21 are formed in a lower portion of the cabinet 2. The coin payout portion serves to payout coins when the exchange button or the payout button is operated. The coin tray 21 serves to receive coins that were paid out from the coin payout portion. A coin detecting portion is arranged in the coin payout portion. The coin detecting portion is composed of a sensor or the like. The coin detecting portion detects the number of coins paid out from the coin payout portion.

Further, a light emitting portion 25 is arranged around the cabinet 2 of the slot machine 1. When a player wins a prize or plays a free game, the light emitting portion 25 lights in a predetermined lighting style. A speaker 34 for audio output is arranged on a side surface of the cabinet 2. The light emitting portion 25 and the speaker 34 can be arranged at arbitrary positions, respectively.

As shown in FIG. 2, the slot machine 1 includes a topper effect device 27 on an upper portion of the cabinet 2. This topper effect device 27 has a rectangular board shape. The topper effect device 27 is arranged in substantially parallel to the upper display portion 3A. The topper effect device 27 displays various kinds of information. The shape of the topper effect device 27 can be designed an arbitrarily.

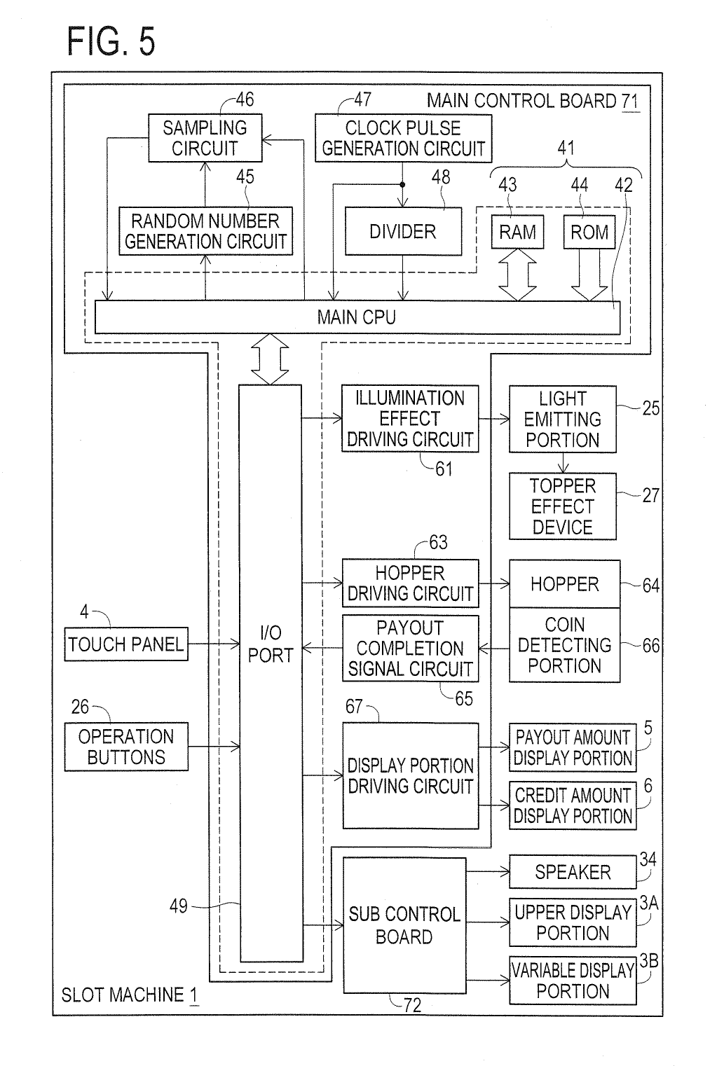

Next, an internal configuration of the slot machine 1 will next be described with reference to the drawings. FIG. 5 is a block diagram showing the internal configuration of the overall slot machine 1. As shown in FIG. 5, the slot machine 1 has a main control board 71 including a controller 41, as a functional core. The slot machine 1 has a plurality of components. The main control board 71 has the controller 41, a random number generation circuit 45, a sampling circuit 46, a clock pulse generation circuit 47, a divider 48, an illumination effect driving circuit 61, a hopper driving circuit 63, a payout completion signal circuit 65, and a display portion driving circuit 67.

The controller 41 has a main CPU 42, a RAM 43, and a ROM 44. The main CPU 42 operates according to a program stored in the ROM 44 and executes the input and output of signals with other components through I/O port 49. That is, the main CPU 42 controls overall operations of the slot machine 1. The RAM 43 stores data and programs that are used during the operation of the main CPU 42. For example, the RAM 43 temporarily stores a random number value sampled by the sampling circuit 46 after the game is started. The RAM 43 stores code numbers corresponding to the reel display portions 101 through 105, respectively. The ROM 44 stores various control programs which executed by the main CPU 42 and permanent data.

The programs stored in the ROM 44 include a game program and a game system program (hereinafter, “game program and the like”). The game program includes a lottery program.

This lottery program is executed when determining a code number corresponding to a symbol stopped at a middle portion of the reel display portions 101 through 105 of the variable display portion 3B (that is, symbol display areas 111B, 112B, 113B, 114B, and 115B).

The lottery program includes symbol weighting data. The symbol weighting data shows a corresponding relationships between the respective code numbers and one or more random number values within a predetermined numerical value range (for example, 0 through 25). The probability of lottery with respect to each symbol on the reel band is set by associating one or a plurality of random number values to one code number. The random number values are drawn by lottery and symbols which are identified as final from the random number values are displayed in a predetermined area on the variable display portion 3B.

The random number generation circuit 45 is operated according to a command from the main CPU 42, and thus generates random numbers in a predetermined range. The sampling circuit 46 extracts arbitrary random number from the random numbers generated by the random number generation circuit 45 according to the command from the main CPU 42. The sampling circuit 46 inputs the extracted random number to the main CPU 42. The clock pulse generation circuit 47 generates a reference clock that is used to operate the main CPU 42. The divider 48 inputs a signals, which are obtained by dividing the reference clock at a predetermined length of cycle, to the main CPU 42.

The touch panel 4 is connected to the main control board 71. As described above, the touch panel 4 is arranged in front of the variable display portion 3B. The touch panel 4 identifies a coordinate position of a portion touched by the player. Therefore, the touch panel 4 can judge a player's operation (e.g., which portion the player touches or in which direction the touched portion moves) based on the information of coordinate position that is identified. A signal depending on the judgment is input to the main CPU 42 through the I/O port 49.

The operation buttons 26 (the start button described above or the like), which are used to command the executing of a game, are connected to the main control board 71 through the operation switch. Therefore, a signal in accordance with a depressing operation of operation button 26 is input to the main CPU 42 through the I/O port 49.

The illumination effect driving circuit 61 executes an illumination effect on the light emitting portion 25 and the topper effect device 27 by outputting an effect signal according to the command from the main CPU 42. The topper effect device 27 is connected to the illumination effect driving circuit 61 through the light emitting portion 25.

The hopper driving circuit 63 drives a hopper 64 according to control of the main CPU 42. The hopper 64 executes a predetermined operation, and pays out coins to the coin payout portion. The coin detecting portion 24 counts the number of coins paid out by the hopper 64. The coin detecting portion 24 inputs coin amount data showing that was detected to the payout completion signal circuit 65. The payout completion signal circuit 65 receives the coin amount data from the coin detecting portion 24. When the received coin amount data reaches the set coin amount, the payout completion signal circuit 65 inputs to the main CPU 42 a signal which notifies the completion of coin payout. The display portion driving circuit 67 controls display operations of respective display portion including the payout amount display portion 5 and the credit amount display portion 6 and the like.

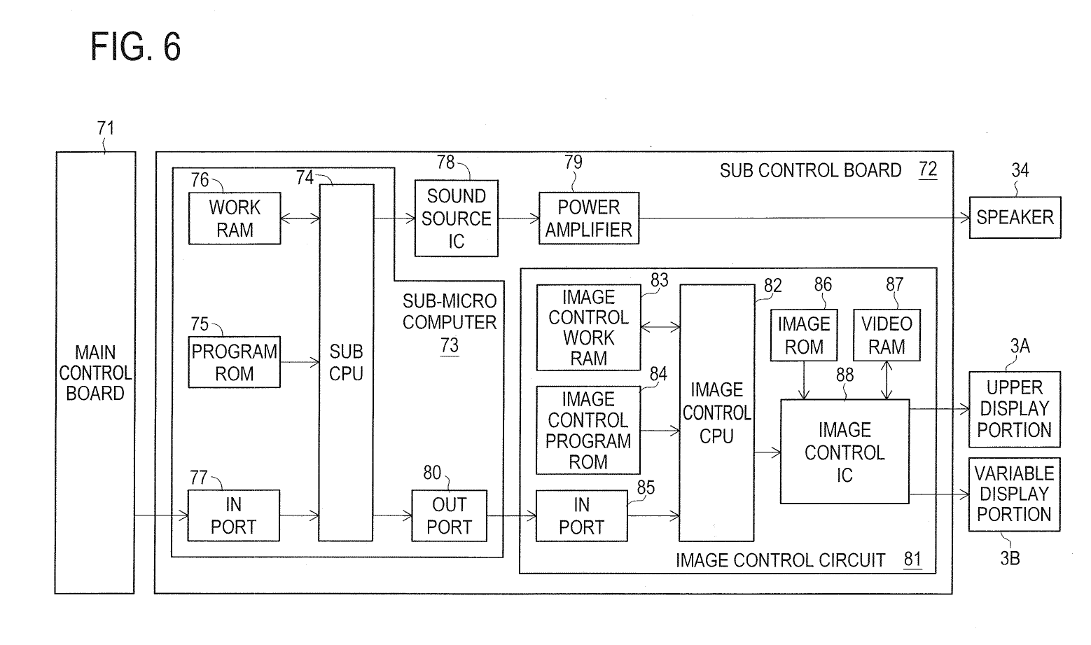

A sub control board is connected to the main control board 72. As shown in FIG. 6, the sub control board 72 controls display of the respective display portions and the audio output from the speaker 34 based on a command input from the main control board 71. The sub control board 72 is arranged on a circuit board different from a circuit board constituting the main control board 71. The sub control board 72 has a microcomputer (hereinafter, “sub-micro computer 73”) as a main component. The sub control board 72 has a sound source IC 78, a power amplifier 79, and an image control circuit 81. The sound source IC 78 controls audio output from the speaker 34. The power amplifier 79 functions as an amplifier that amplifies the audio output from the speaker 34. The image control circuit 81 functions as a display control device for the upper display portion 3A and the variable display portion 3B.

The sub-micro computer 73 has a sub CPU 74, a program ROM 75, a work RAM 76, and I/O ports 77 and 80. The sub CPU 74 executes control operation according to a control command transmitted from the main control board 71. The program ROM 75 stores a control program that was executed by the sub CPU 74. The work RAM 76 is composed of a temporary memory when the control programs are executed in the sub CPU 74.

The sub control board 72 does not include a clock pulse generation circuit, a divider, a random number generator, and a sampling circuit. In this regard, the sub control board 72 executes random number sampling on an operation program of the sub CPU 74.

The image control circuit 81 has an image control CPU 82, an image control work RAM 83, an image control program ROM 84, an image ROM 86, a video RAM 87, and an image control IC 88. The image control CPU 82 determines images to be displayed on the upper display portion 3A and the variable display portion 3B based on a parameter set by the sub-micro computer 73 and an image control program.

For example, the image control CPU 82 displays the payout table and a help screen on the upper display portion 3A. Further, the image control CPU 82 variably displays or stopped in the symbol display areas 111A through 111C, 112A through 112C, 113A through 113C, 114A through 114C, and 115A through 115C of the variable display portion 3B.

Moreover, the image control CPU 82 combines the symbol reel band 90 and the background reel band 95 in a composite reel band generation process (S13) based on the control signal from the main CPU 42. Namely, the image control CPU 82 generates the composite reel band 100.

The image control program ROM 84 stores therein the image control program and various selection tables related to display of the upper display portion 3A and the variable display portion 3B. The image control work RAM 83 functions as a temporary memory when the image control program executed by the image control CPU 82.

The image control IC 88 forms images that corresponding to the contents determined by the image control CPU 82. The image control IC 88 outputs the formed images to the upper display portion 3A and the variable display portion 3B.

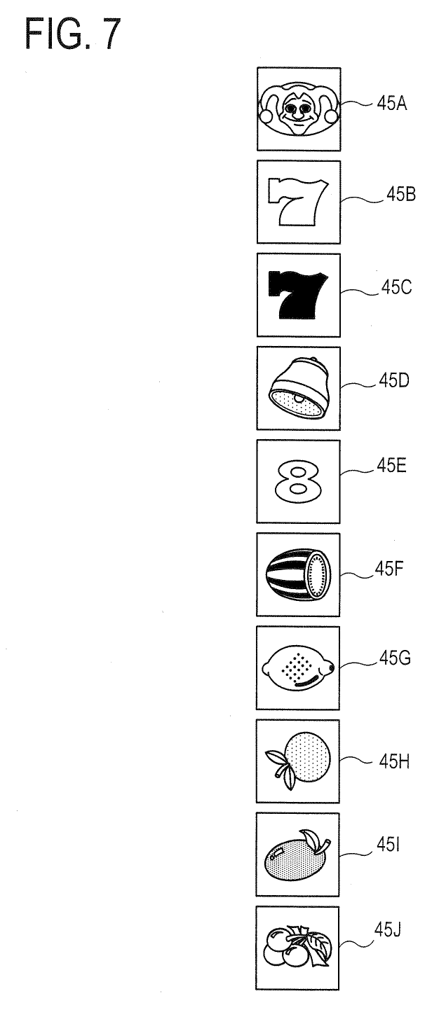

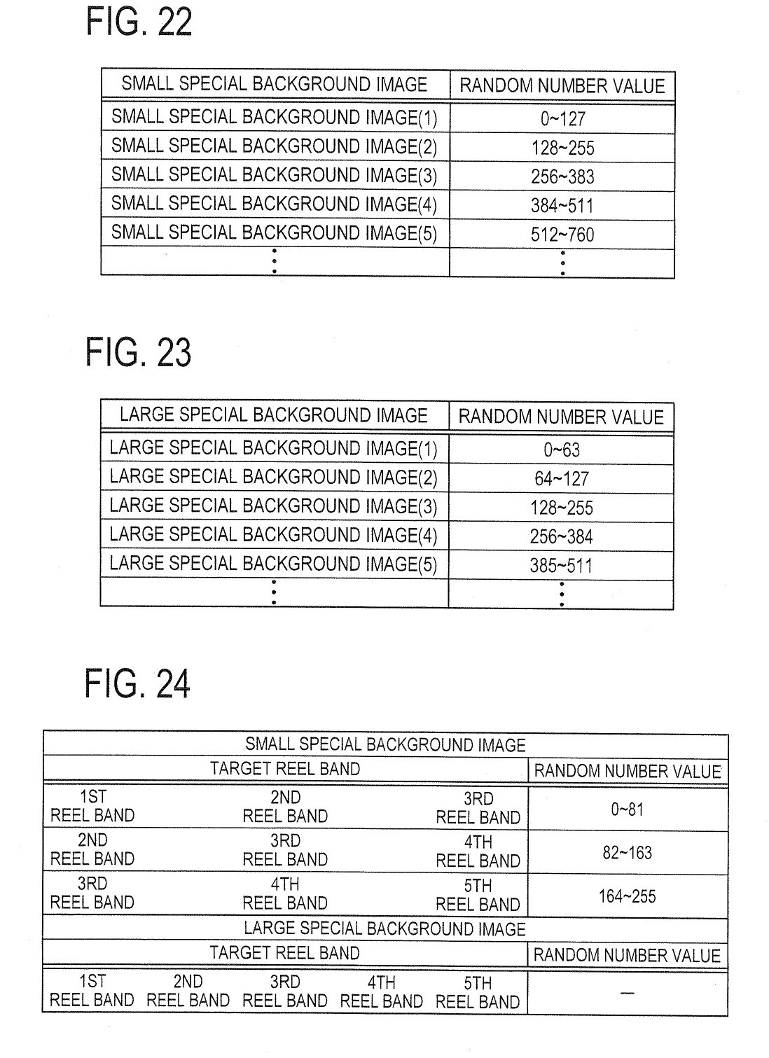

The image ROM 86 stores dot data that is used to form images. Specifically, this image ROM 86 stores dot data on respective symbols constituting the symbol reel band 90 (refer to FIG. 7) and dot data on the special background image (that is, the small special background image 50 or the large special background image 55). This image ROM 86 stores a plural kinds of small special background images 50 and a plural kinds of large special background images 55 (refer to FIGS. 22 and 23). The special background image is stored in the image ROM 86 as a set of unit background images. A unit background image is obtained by dividing the special background image per symbol display area.

The video RAM 87 functions as a temporary memory when the images are formed by the image control IC 88.

The internal configuration of the slot machine 1 described above is a merely example and is not limited to the above configuration. For example, a memory card or a PLD (Programmable Logic Device) may be attached to or detached from the slot machine 1. In this case, the slot machine 1 may be configured to read necessary information from the memory card or the PLD.

In the slot machine 1 according to the invention, coins, bills or electronic valuable information (credit) corresponding to the coins or bills is used as gaming value,. However, gaming values, which can be applied to the invention, is not limited thereto. For example, the slot machine may be formed to be capable of using medals, tokens, electronic money or tickets as the gaming values.

The composite reel band 100 variably displayed in the variable display portion 3B will next be described in detail with reference to the drawings. As described above, the composite reel band 100 is generated by combining the symbol reel band 90 and the background reel band 95 in the composite reel band generation process (S13) to be described later (refer to FIG. 17).

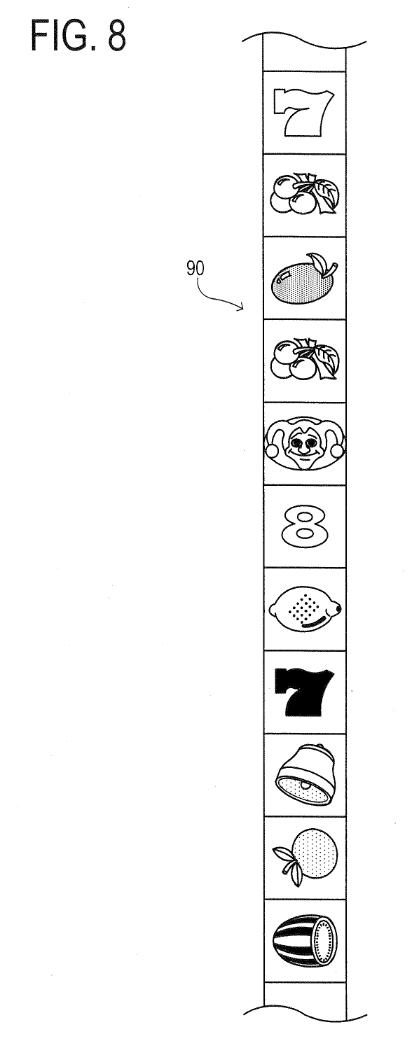

The symbol reel band 90 used to generate the composite reel band 100 will first be described in detail with reference to the drawings. FIG. 7 shows an example of symbols constituting the symbol reel band 90. FIG. 8 is an explanatory diagram showing an example of the symbol reel band 90.

As shown in FIGS. 7 and 8, the symbol reel band 90 according to the embodiment includes a joker symbol 45 (JOKER), a red seven symbol 45B (RED 7), a blue seven symbol 45C (BLUE 7), a bell symbol 45D (BELL), an eight symbol 45E (EIGHT), a watermelon symbol 45F (WATERMELON), a lemon symbol 45G (LEMON), an orange symbol 45H (ORANGE), a plum symbol 45I (PLUM), and a cherry symbol 45J (CHERRY).

As shown in FIG. 8, the various symbols shown in FIG. 7 are drawn in a predetermined order on the symbol reel band 90. In this regard, the symbol reel band 90 shown in FIG. 8 is a mere example. The order in which the symbols are drawn may be determined arbitrarily. The number of symbols drawn on one reel band is determined arbitrarily, and kinds of to be drawn symbols may be defined arbitrarily.

In the slot machine 1 according to the embodiment, each of the reel display portions 101 through 105 of the variable display portion 3B is associated with one symbol reel band 90, respectively.

Next, the background reel band 95 constituting the composite reel band 100 will be described in detail with reference to the drawings.

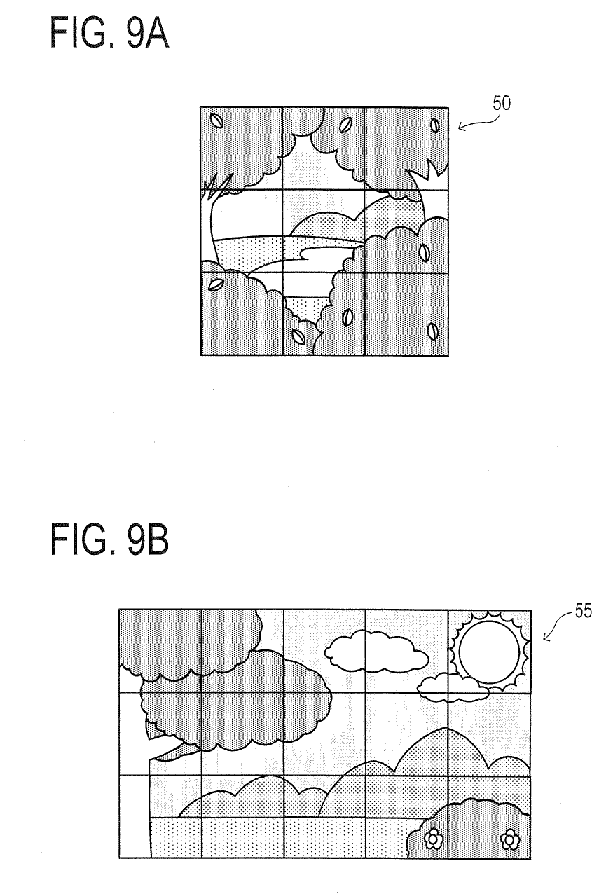

The special background image based on which background images constituting the background reel band 95 are generated will be described in detail. FIGS. 9A and 9B are explanatory diagrams showing an example of the special background image according to the embodiment.

The special background image according to the embodiment is an image of a size corresponding to a plurality of symbol display areas arranged in a matrix. The special background image is classified into two kinds of the small background image 50 and the large background image 55.

As shown in FIG. 9A, the small special background image 50 is a special background image of a size corresponding to symbol display areas arranged in a matrix of 3×3. The small special background image 50 is constituted by nine unit background images. A unit background image related to the small special background image 50 is obtained by dividing the small special background image 50 per symbol display area. Therefore, the slot machine 1 can reproduce the small special background image 50 by arranging the nine unit background images at predetermined positions, respectively.

The unit background images constituting the small special background image 50 are classified into the first partial background images 50A, the second partial background images 50B, and the third partial background images 50C.

The first partial background images 50A are images in portions belonging to a left column (hereinafter, “first column”) of the small special background image 50 constituted by the nine unit background images arranged in the matrix of three rows by three columns. Namely, the first partial background images 50A are constituted by three unit background images belonging to the first column of the small special background image 50 (that is, the unit background images located in an upper row, a middle row, and a lower row of the first column, respectively). It is to be noted that the arrangement of the unit background images in the first partial background images 50A is similar to that in the small special background image 50.

The second special background images 50B are images in portions belonging to a central column (hereinafter, “second column”) of the small special background image 50. Namely, the second special background images 50B are constituted by three unit background images belonging to the second column of the small special background image 50. The second special background images 50B are arranged similarly to the second column portion of the small special background image 50.

The third special background images 50C are images in portions belonging to a right column (hereinafter, “third column”) of the small special background image 50. Namely, the third special background images 50C are constituted by three unit background images belonging to the third column of the small special background image 50. The third special background images 50C are arranged similarly to the third column portion of the small special background image 50.

Accordingly, if the first partial background images 50A through the third special background images 50C are arranged at predetermined positions, respectively, the slot machine 1 can reproduce the small special background image 50.

The large special background image 55 is a special background image of a size corresponding to symbol display areas arranged in a matrix of 3×5. This large special background image 55 is constituted by fifteen unit background images. The unit background image related to the large special background image 55 is obtained by dividing the large special background image 55 per symbol display area. Accordingly, the slot machine 1 can reproduce the large special background image 55 by arranging the fifteen unit background images at predetermined positions, respectively.

The unit background images constituting the large special background image 55 are classified into the first partial background images 55A, the second partial background images 55B, the third partial background images 55C, the fourth partial background images 55D, and the fifth partial background images 55E.

As described above, the large special background image 55 is constituted by the fifteen unit background images arranged in the matrix of three rows by five columns. In the embodiment, five columns constituting the large special background image 55 are referred to as “a first column, a second column, a third column, a fourth column, and a fifth column” from left in order, respectively.

Each of the first partial background images 55A through the fifth partial background images 55E are images constituted by three unit background images belonging to a certain column of the large special background image 55. The first partial background images 55A are constituted by three unit background images belonging to the first column of the large special background image 55 (that is, three unit background images belonging to an upper row, a center row, and a lower row of the first column, respectively). The second partial background images 55B are constituted by three unit background images belonging to the second column of the large special background image 55. Likewise, each of the third partial background images 55C through the fifth partial background images 55E correspond to the third column, the fourth column or the fifth column of the large special background image 55, respectively. Each of the third partial background images 55C through the fifth partial background images 55E are constituted by three unit background images belonging to the third column, the fourth column or the fifth column of the large special background image 55. The unit background images in the first partial background images 55A through the fifth partial background images 55E are arranged similarly to the corresponding columns of the large special background image 55, respectively.

Accordingly, if the first partial background images 55A through the fifth partial background images 55E are arranged at predetermined positions, respectively, the slot machine 1 similarly reproduce the large special background image 55.

The background reel band 95 based on the special background image will next be described in detail with reference to the drawings.

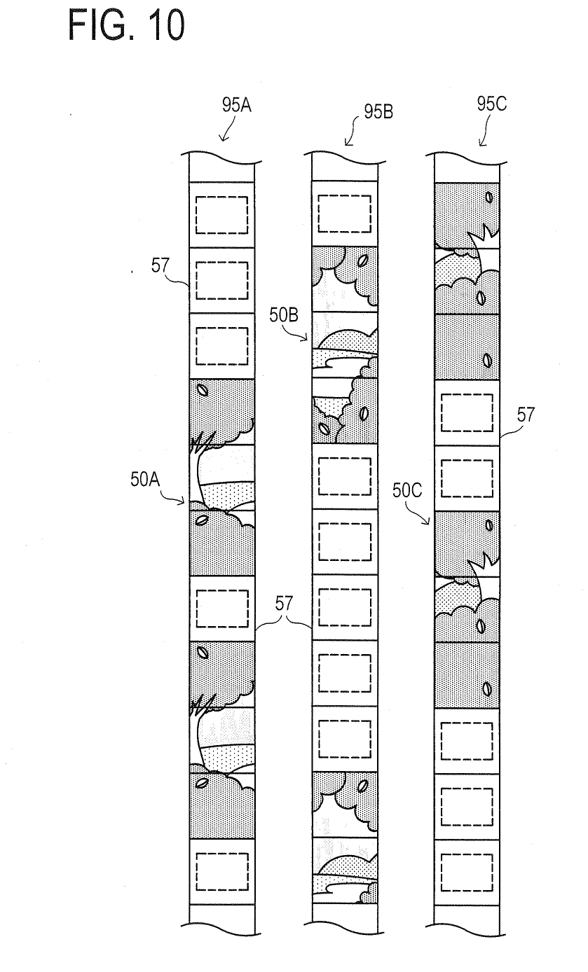

The background reel band 95 based on the small special background image 50 will first be described in detail with reference to FIG. 10. FIG. 10 is an explanatory diagram showing an example of the background reel band 95 based on the small special background image 50.

As shown in FIG. 10, the background reel band 95 based on the small special background image 50 includes the first background reel band 95A through the third background reel band 95C.

The first background reel band 95A based on the small special background image 50 is constituted by arranging the first partial background images 50A and plain background images 57 in a predetermined order. As described above, the first partial background image 50A is an image constituted by the three unit background images belonging to the first column of the small special background image 50 (refer to FIGS. 9A and 10). The plain background image 57 is an image showing a plain background of a size corresponding to one symbol display area.

The second background reel band 95B based on the small special background image 50 is constituted by arranging the second partial background images 50B and plain background images 57 in a predetermined order. As described above, the second partial background image 50B is an image constituted by the three unit background images belonging to the second column of the small special background image 50 (refer to FIGS. 9A and 10). Then, the third background reel band 95C based on the small special background image 50 is constituted by arranging the third partial background images 50C and plain background images 57 in a predetermined order. The third partial background image 50C is an image constituted by the three unit background images belonging to the third column of the small special background image 50 (refer to FIGS. 9A and 10).

Therefore, in this case, by arranging the first background reel band 95A through the third background reel band 95C from left in order, the first partial background images 50A through the third partial background images 50C can be arranged in a predetermined order. As a result, the slot machine 1 can reproduce the small special background image 50 by the first special background images 50A through the third special background images 55C (refer to FIGS. 9A and 10).

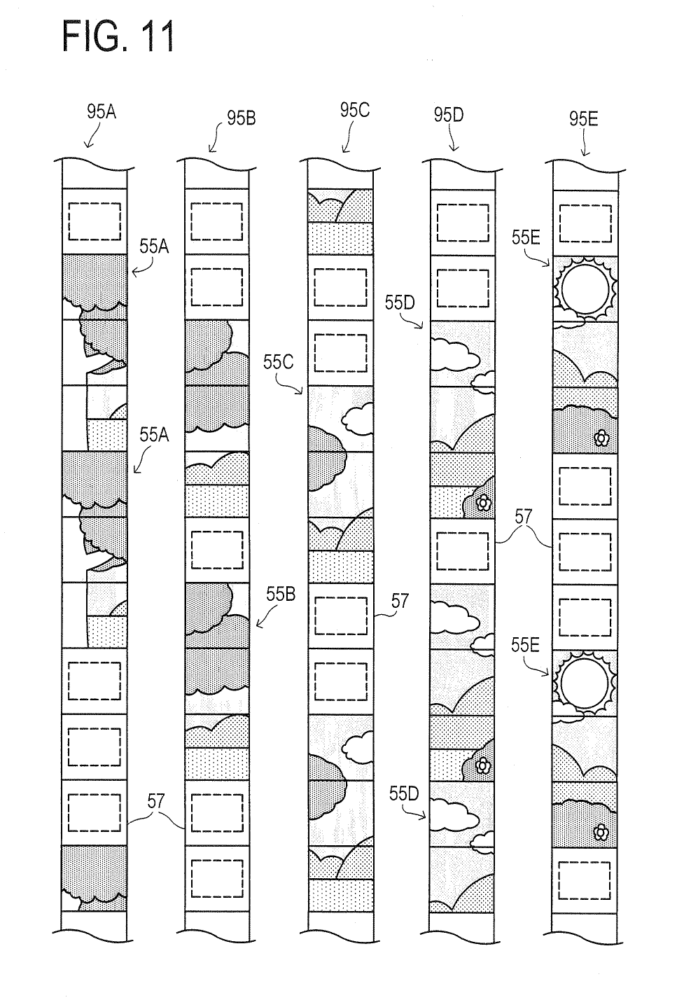

Next, the background reel band 95 based on the large special background image 55 will next be described in detail with reference to FIG. 11. FIG. 11 is an explanatory diagram showing an example of the background reel band 95 based on the large special background image 55.

As shown in FIG. 11, the background reel band 95 based on the large special background image 55 includes the first background reel band 95A through the fifth background reel band 95E.

The first background reel band 95A based on the large special background image 55 is constituted by arranging first partial background images 55A and plain background images 57 in a predetermined order (refer to FIG. 11). As described above, the first partial background image 55A is constituted by the three unit background images belonging to the first column of the large special background image 55 (refer to FIGS. 9B and 11). The second background reel band 95B is constituted by arranging second partial background images 55B and plain background images 57 in a predetermined order. Likewise, the third background reel band 95C through the fifth partial background reel band 95E are constituted by corresponding partial background images (that is, the third partial background images 55C through the fifth partial background images 55E) and plain background images 57 in predetermined orders, respectively (refer to FIGS. 9B and 11).

Therefore, in this case, if the first background reel band 95A through the fifth background reel band 95E are arranged from left in order, the first partial background images 55A through the fifth partial background images 55E can be arranged in a predetermined order. As a result, the slot machine 1 can reproduce the large special background image 55 by the first partial background images 55A through the fifth partial background images 55E (refer to FIGS. 9B and 11).

A game played using the slot machine 1 will be described. In the game executed in the slot machine 1, all symbols are scatter symbols. Namely, in the game according to the embodiment, a prize is awarded to the player based on the number of the same symbols displayed in the symbol display areas 111A through 111C, 112A through 112C, 113A through 113C, 114A through 114C, and 115A through 115C arranged in the matrix of 3×5 (refer to FIG. 14).

In the embodiment, whether or not the symbols are the same is determined only by sameness of symbols. That is, sameness of background images is not considered in the determination as to whether or not the symbols are the same.

At the start of the game in the slot machine 1, the player sets the bet amount by operating the BET button. After that, the player depresses the start button. At this time, the composite reel band 100 is generated based on the symbol reel band 90 and the background reel band 95 (refer to FIG. 17). The composite reel bands 100 is associated with each of the reel display portions 101 through 105, respectively.

The composite reel band 100 starts rotating in each of the reel display areas 101 through 105 based on depression of the start button. That is, in each of the reel display portions 101 through 105, the composite symbols drawn on the composite reel band 100 are scroll-displayed downward (refer to FIG. 12). Each of the composite symbols is constituted by combining symbols constituting the symbol reel band 90 and unit background images constituting the background reel band 95.

When a predetermined time has elapsed, the composite reel band 100 is stopped in each of the reel display portions 101 through 105. Accordingly, a part of a composite symbol column constituting each composite reel band 100 (three composite symbols constituting each composite reel band 100) is stopped in each of the reel display portions 101 through 105. That is, as shown in FIG. 13, one composite symbol is stopped respectively in each of the three symbol display areas constituting each of the reel display portions 101 through 105. As a result, fifteen composite symbols are stopped in the variable display portion 3B (refer to FIG. 13).

As described above, in the game according to the embodiment, a winning combination is determined based on the number of same symbols displayed in the variable display portion 3B. A prize corresponding to the winning combination is awarded to the player. In the winning in the winning combination, the player will be awarded an amount obtained by multiplying a payout amount corresponding to the winning combination by the bet amount (refer to FIG. 14). This point will be described later.

Furthermore, if one special background image (e.g., the small special background image 50 or the large special background image 55) is reproduced in the variable display portion 3B by the background images constituting the fifteen composite symbols stopped (refer to FIGS. 1A and 1B and the like), a predetermined number of free games are awarded to the player as a bonus game. This point will be described later.

The content of a winning combination and a the prize in the slot machine 1 according to the embodiment will be described with reference to the drawings. FIG. 14 is an explanatory diagram showing the payout table according to the embodiment.

As shown in FIG. 14, winning combinations are associated with awarded prizes (that is, payout amounts) respectively, in the payout table. In this regard, the payout amount of the payout table shown in FIG. 14 is the payout amount when the bet amount is “1”. Namely, when the bet amount is “1”, the payout amount shown in FIG. 14 is paid out. When the bet amount is “2” and more, the amount obtained by multiplying the bet amount by the payout amount shown in FIG. 14 will be paid out.

For example, if five blue seven symbols 45C are displayed in the fifteen symbol display areas (the symbol display areas 111A through 111C, 112A through 112C, 113A through 113C, 114A through 114C, and 115A through 115C) in the variable display portion 3B, an “amount obtained by multiplying the bet amount by 150 credits” will be paid out to the player (refer to FIG. 14).

If four watermelon symbols 45F are displayed in the fifteen symbol display areas in the variable display portion 3B, an “amount obtained multiplying the bet amount by 8 credits” will be paid out to the player (refer to FIG. 14). Payout amounts are set for each winning combinations in a similar manner, as shown in FIG. 14.

In the embodiment, if one special background image is reproduced by the background images constituting the fifteen composite symbols stopped in the variable display portion 3B (for example, refer to FIGS. 1A and 1B or the like), not the payout amount but the bonus game is awarded to the player. Specifically, so-called free games are awarded to the player as the bonus game. The free game is a game that can be executed without new credits bet by the player.

In this regard, if the symbols displayed in the fifteen symbol display areas in the variable display portion 3B do not correspond to any one of the winning combinations shown in FIG. 14, the game is lost. In this case, payout amount corresponding to the loss and prize are not executed.

In this respect, even if the game is lost, the bonus game is awarded to the player as long as one special background image is reproduced in the variable display portion 3B.

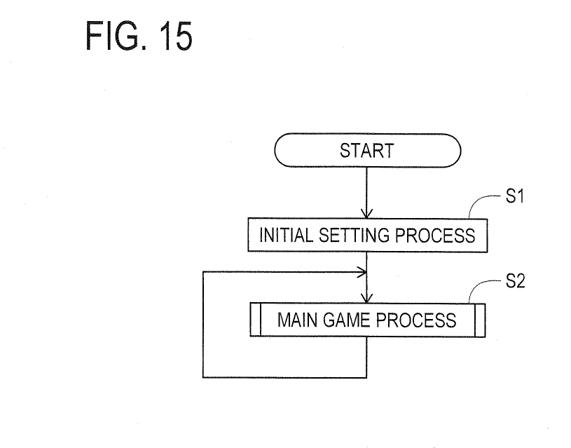

The main control program executed in the slot machine 1 according to the embodiment will be described in detail with reference to the drawings. FIG. 15 is a flowchart of the main control program.

When the power switch is turned on (upon power on), the main control board 71 and the sub control board 72 are activated. The controller 41 executes an initial setting process (S1). In the initial setting process (S1), the main CPU 42 executes BIOS stored in the ROM 42, and expands the compressed data incorporated in the BIOS in the RAM 43. In executing the BIOS that was expanded in the RAM 43, the main CPU 42 carries out a diagnosis and initialization of the various peripheral devices. Furthermore, the main CPU 42 writes the game program and the like from the ROM 44 to the RAM 43. The main CPU 42 acquires payout rate setting data and country identification information. While executing the initial setting process (S1), the main CPU 42 also carries out an authentication process with respect to each program.

When the initial setting process (S1) is terminated, the main CPU 42 executes a main game process (S2). In this main game process (S2), the main CPU 42 sequentially reads the game program and the like from the RAM 43 and executes the game program and the like. By executing this main game process (S2), the game in the slot machine 1 according to the embodiment is executed.

the main game process (S2) is repeatedly executed while electric power supplied to the slot machine 1.

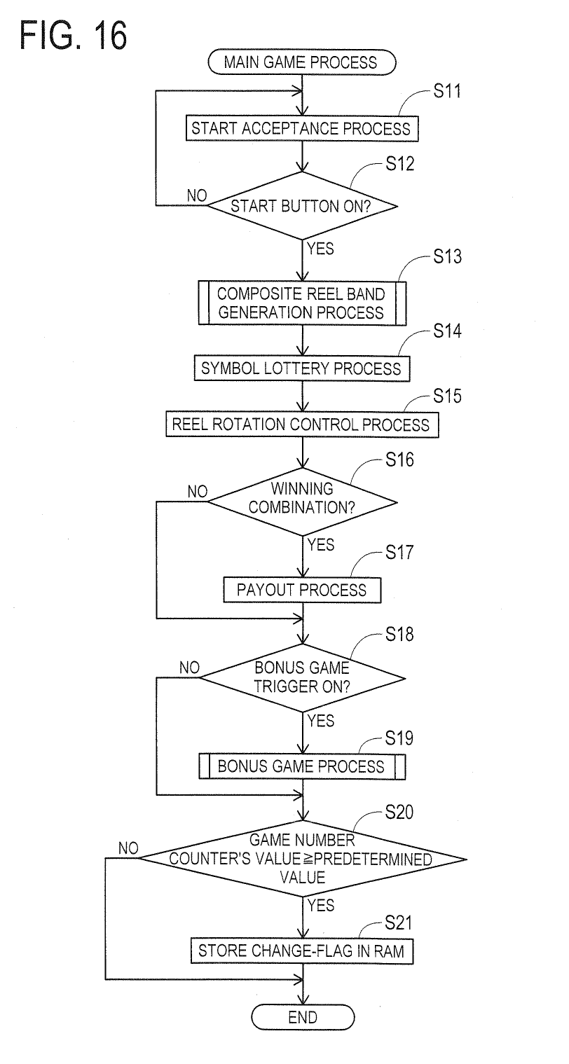

Next, a main game process program executed in the main game process (S2) will be described with reference to the drawings. FIG. 16 is a flowchart of the main game process program executed by the slot machine 1 according to the embodiment. Each program shown in the following flowchart is stored in the ROM 44 or the RAM 43 of the slot machine 1 and executed by the main CPU 42.

As shown in FIG. 16, the main CPU 42 executes a start acceptance process (S11). In the start acceptance process (S11), the player inserts coins and executes bet operation using the BET button of the operation buttons 26.

After shifting to S12, the main CPU 42 judges whether the start button of the operation buttons 26 is pressed or not. The main CPU 42 judges the presence/absence of an input to the start button by the presence/absence of a signal based on depression of the start button. If the start button is pressed (S12: YES), the main CPU 42 subtracts the bet amount set based on the bet operation from the credit amount that the player currently possesses. The main CPU 42 stores the subtraction result in the RAM 43 as bet information. The subtraction of the credit amount and the storing of the bet information are terminated, the main CPU 42 shifts the process to S13. On the other hand, if the start button is not pressed (S12: NO), the main CPU 42 returns the process to the start acceptance process (S11). Accordingly, the player can perform operations, such as correction of the bet amount.

After shifting to S13, the main CPU 42 executes a composite reel band generation process. In the composite reel band generation process (S13), the main CPU 42 generates the composite reel band 100 based on the symbol reel band 90 and the background reel band 95 (refer to FIG. 17). Then, the main CPU 42 associates the generated composite reel band 100 to each of the reel display portions 101 through 105. The composite reel band generation process (S13) will be described later in detail with reference to the drawings. The composite reel band generation process (S13) will be omitted herein. When the composite reel band generation process (S13) is terminated, the main CPU 42 shifts the process to S14.

In S14, the main CPU 42 executes a symbol lottery process. In the symbol lottery process (S14), the main CPU 42 executes a lottery program stored in the RAM 43 in order to sample a random number value in a numerical value range of a predetermined random number value range. The main CPU 42 determines composite symbols stopped in the middle portions of the respective reel display portions 101 through 105 (that is, the symbol display areas 111B, 112B, 113B, 114B, and 115B) based on the sampled random numbers and the table.

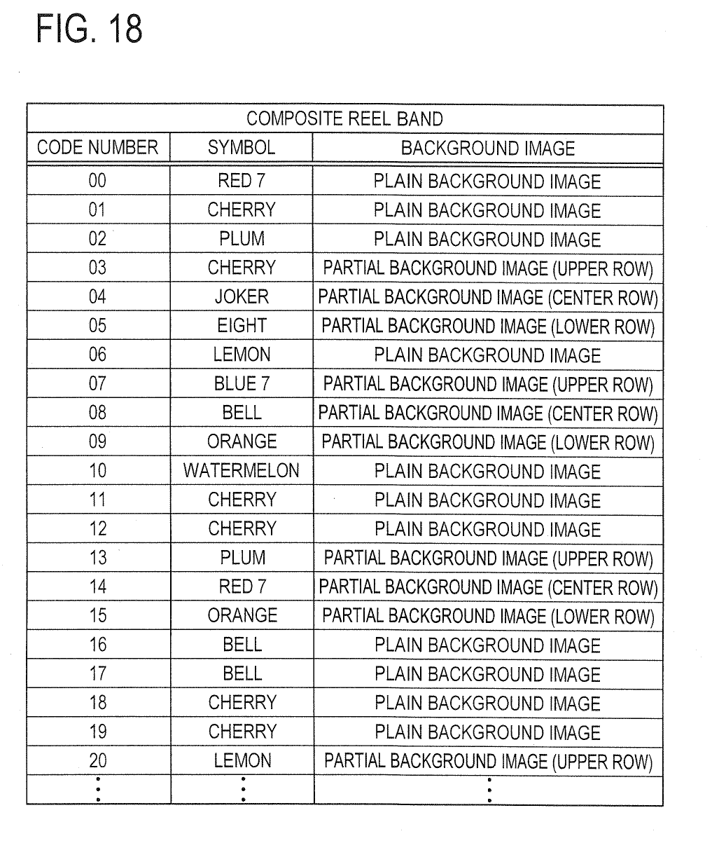

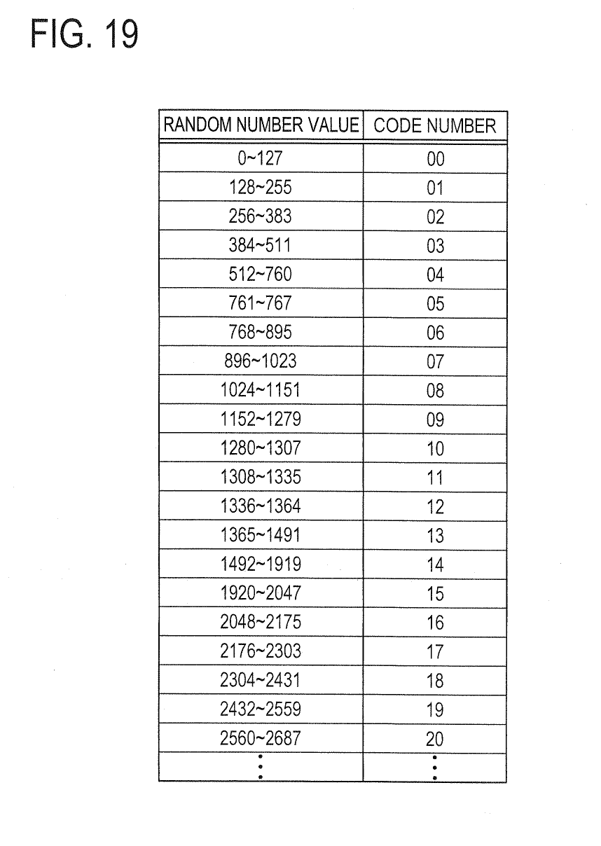

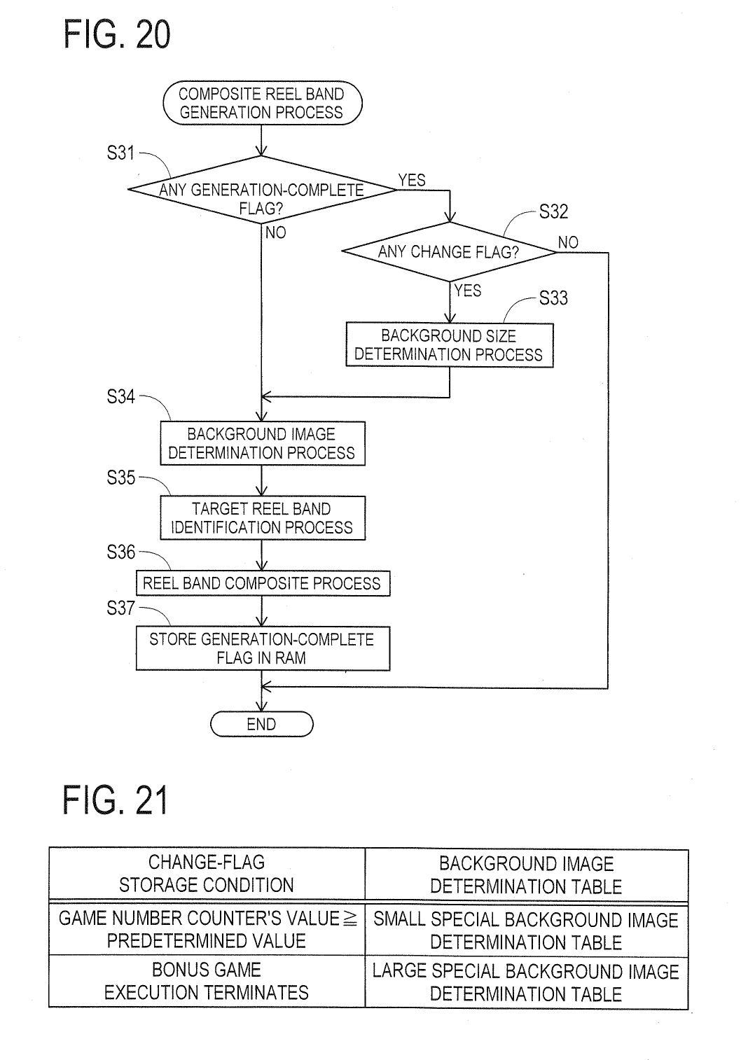

The process using the random number values in the symbol lottery process (S14) will be described with reference to the drawings. FIG. 18 is an example of a table associating composite symbols (that is, kinds of symbols and unit background images) drawn on a certain composite reel band and code numbers. FIG. 19 is an example of a table associating the random number values and the code numbers.

In this regard, the table associating the composite symbols and the code numbers (for example, refer to FIG. 18) is exist so as to be associated with each of the reel display portions 101 through 105.

As described above, in the symbol lottery process (S14), the main CPU 42 executes the lottery program in order to sample random number values in a predetermined random number range (e.g., 0 through 65535). After that, the main CPU 42 determines code numbers based on the sampled random number value and the table associating the random number values and the code numbers (for example, refer to FIG. 19). When determining the code numbers, the main CPU 42 determines the composite symbols to be stopped in the middle portions of the reel display portions 101 through 105 based on the determined code numbers and the table associating the composite symbols and the code numbers (refer to FIG. 18).

For example, if the composite reel band 100 shown in FIG. 18 is used in the reel display portion 101 and a random number value “1291” is sampled, the main CPU 42 determines a code number “10” based on the random number value “1295” and the table shown in FIG. 19. In this case, the main CPU 42 determines a composite symbol constituted by the watermelon symbol 45F and the plain background images 57 as the symbol stopped in the symbol display area 111B based on the code number “10” and the table shown in FIG. 18.

The process using the random number values in the symbol lottery process (S13) is not limited to the mode using the random number values, the table associating the random number values and the code numbers (for example, refer to FIG. 19), and the table associating the composite symbols and the code numbers (refer to FIG. 18).

For example, the sampled random number values may be directly associated with the composite symbols. Further, the sampled random number values may be directly associated with the winning combinations, and the symbols to be stopped may be determined using a table associating the random number values and the winning combinations.

Referring to FIG. 16 again, a process in executing the main game process program following the symbol lottery process (S14) will be described.

After the symbol lottery process (S14) is terminated, the main CPU 42 executes a reel rotation control process (S15). In the reel rotation control process (S15), the main CPU 42 variably displays the composite reel bands 100 at predetermined speed on the reel display portions 101 through 105. After that, the main CPU 42 determines effect patterns of a unit game (pattern of a display of an image on the variable display portion 3B, an audio output from the speaker 34, and the like). The main CPU 42 starts an effect based on the determined effect patterns by controlling the sub control board 72 and the like. The “unit game” means a game that is to be executed by a series of processes until all the composite reel bands 100 are stopped from the time when each of the composite reel band 100 begins to be variable displayed.

When a predetermined time has elapsed, the main CPU 42 stops the composite reel bands 100 on the reel display portions 101 through 105 in a predetermined order. As a result, one composite symbol is stopped in each of the fifteen symbol display areas (that is, the symbol display areas 111A through 111C, 112A through 112C, 113A through 113C, 114A through 114C, and 115A through 115C) on the variable display portion 3B.

With respect to the stop of the composite reel band 100 on each of the reel display portions 101 through 105, the composite symbols on all the reel display portions may be stopped at one time. And, the composite symbols may be sequentially stopped at different times.

The stop of a symbols will be described in detail with reference to the example of the reel display portion 101 that has been described in the symbol lottery process (S14). According to the above-mentioned specific example, the “composite symbol constituted by the watermelon symbol 45F and the plain background images 57” (code number: 10) determined in the symbol lottery process (S14) is stopped in the symbol display area 111B that is the middle portion of the reel display portion 101. In this case, a “composite symbol constituted by the orange symbol 45H and the unit background images constituting the lower row of the partial background image” (code number: 09) is displayed in the symbol display area 111A constituting the upper portion of the reel display portion 101. Further, a “composite symbol constituted by the cherry symbol 45J and plain background images 57” (code number: 11) is displayed in the symbol display area 111C constituting the lower portion of the reel display portion 101.

After the reel rotation control process (S15), the main CPU 42 judges whether the symbols stopped in the variable display portion 3B correspond to one of winning combinations (S16). Specifically, the main CPU 42 identifies kinds of symbols constituting the stopped composite symbols (that is, the joker symbol 45A through the cherry symbol 45J) based on the code number of the respective reel display portions 101 through 105 stored in the RAM 43. The main CPU 42 judges whether or not the symbols correspond to one of winning combinations.

In this process in S16, the main CPU 42 adds “1” to a game number counter formed in the RAM 43. A value of this game number counter indicates the number of times of execution of the unit game. The value of the game number counter is referred to in S20 to be described later.

If the winning combination is established (S16: YES), the main CPU 42 calculates a payout amount corresponding to the winning combination based on the payout table (refer to FIG. 14). After that, the main CPU 42 shifts the process to S17. On the other hand, if any winning combination is not established (S16: NO), the main CPU 42 shifts the process to S18.

After shifting to S17, the main CPU 42 executes a payout process. In the payout process (S17), the main CPU 42 pays out the payout amount according to the winning combination determined in S16 to the player. When the payout process (S17) is terminated, the main CPU 42 shifts the process to S18.

In S18, the main CPU 42 judges whether or not a bonus game trigger is achieved. Specifically, the main CPU 42 identifies the background images of the composite symbol stopped in each symbol display area based on the code numbers of the respective reel display portions 101 through 105 stored in the RAM 43. The main CPU 42 judges “whether or not one special background image is displayed in the variable display portion 3B”.

The judgment process in S18 will be described in more detail. In the judgment process in S18, the main CPU 42 judges whether or not the background image of the composite symbol to be stopped in the middle portion of each reel display portion is the “unit background image corresponding to the center row of the partial background image”.

As described above, the background reel band 95 according to the embodiment is constituted by the partial background images (e.g., the first partial background images 50A) and the plain background images 57. Then, each partial background images are constituted by the three unit background images belonging to a certain column of the special background image. As shown in FIGS. 10, 11, 17 and the like, each partial background image is constituted by the three unit background images arranged similarly to the relevant column. Accordingly, if the unit background image corresponding to the center row of the partial background image is displayed in the middle portion of one reel display portion, the entirety of the partial background image is displayed in the reel display portion.

Therefore, the main CPU 42 can judge whether or not one partial background image included in the composite reel band is displayed entirely in the reel display portion by referring to the code number determined in the symbol lottery process (S14) and the table shown in FIG. 18. Furthermore, the CPU 42 can judge “whether or not one special background image is displayed in the variable display portion 3B” by executing the judgment process described above for all the reel display portions each associated with the composite reel band 100 including the partial background images.

If one special background image is displayed in the variable display portion 3B and the bonus game trigger is achieved (S18: YES), the main CPU 42 shifts the process to a bonus game process (S19). If one special background image is not displayed (for example, refer to FIG. 13) and the bonus game trigger is not achieved (S18: NO), the main CPU 42 shifts the process to S20.

In S19, the main CPU 42 executes the bonus game process. In the bonus game process (S19), the main CPU 42 executes a so-called free game a predetermined times (e.g., ten times). The main CPU 42 awards a prize based on the result of the free game to the player. Furthermore, in this bonus game process (S19), a change-flag accompanying “execution of the bonus game” is stored in the RAM 43. The bonus game process will be described later in detail with reference to the drawings. When the bonus game process (S19) is terminated, the main CPU 42 shifts the process to S20.

After shifting to S20, the main CPU 42 judges whether or not the value of the game number counter is equal to or greater than a predetermined value (e.g., “30”) by referring to the value of the game number counter formed in the RAM 43. As described above, the value of the game number counter is a value indicating the number of times of the unit game executed in the slot machine 1. If the value of the game number counter is equal to or greater than the predetermined value (S20: YES), the main CPU 42 shifts the process to S21. If the value of the game number counter is smaller than the predetermined value (S20: NO), the main CPU 42 ends the main game process program. As described above, the main game process program is re-executed simultaneously with termination of the main game process program.

In S21, the main CPU 42 stores the change-flag in the RAM 43 based on the fact that “the value of the game number counter is equal to or greater than the predetermined value”. This change-flag is referred to when the special background image is changed in a composite reel band generation process program to be described later. After storing the change-flag in the RAM 43, the main CPU 42 terminates the main game process program.

As described above, the main game process (S2) is repeatedly executed while power is supplied to the slot machine 1. That is, when the main game process program terminates, the main CPU 42 starts executing the main game process program again.

Next, the composite reel band generation process program executed in S13 of the main game process program will be described in detail with reference to the drawings.

After shifting to the composite reel band generation process (S13), the main CPU 42 judges first whether or not a generation-complete flag is stored in the RAM 43 (S31). The generation-complete flag is a flag indicating that the composite reel band 100 is generated by the composite reel band generation process (S13). The generation-complete flag is stored in the RAM 43 in S37 to be described later.

If the generation-complete flag is stored in the RAM 43 (S31: YES), the main CPU 42 shifts the process to S32. On the other hand, if the generation-complete flag is not stored in the RAM 43 (S31: NO), the main CPU 42 shifts the process to a background image determination process (S34). Accordingly, right after turning on the slot machine 1 or the like, the main CPU 42 shifts the process to S34 as it is.

In S32, the main CPU 42 judges whether or not the change-flag is stored in the RAM 43. As described above, this change-flag is stored in the RAM 43 if the value of the game number counter is equal to or greater than the predetermined value (S21) or if the execution of the bonus game is terminated (S19, S47). If the change-flag is stored in the RAM 43 (S32: YES), the main CPU 42 shifts the process to a background size determination process (S33). If the change-flag is not stored in the RAM 43 (S32: NO), the main CPU 42 terminates the composite reel band generation process. In this case, the slot machine 1 executes a game based on currently used composite reel bands 100.

After shifting to S33, the main CPU 42 executes the background size determination process. In the background size determination process (S33), the main CPU 42 determines the size of the special background image used to generate the composite reel band 100 according to a change-flag storage condition.

As shown in FIG. 21, if the change flag stored in S21 is present in the RAM 43, the main CPU 42 sets a “small special background image determination table (refer to FIG. 22)” as a background image determination table used in a background image determination process (S34) to be described later. As a result, the main CPU 42 determines one small special background image 50 from a plural kinds of small special background images 50 in the background image determination process (S34) to be described later.

If the change-flag stored in the bonus game process (S19 and S47) is present in the RAM 43, the main CPU 42 sets a “large special background image determination table (refer to FIG. 23)” as the background image determination table used in the background image determination process (S34) to be described later. As a result, the main CPU 42 determines one large special background image 55 from a plural kinds of large special background images 55 in the background image determination process (S34) to be described later. After setting the background image determination table related to the size according to the change-flag storage condition, the main CPU 42 shifts the process to S34.

After shifting to S34, the main CPU 42 executes the background image determination process. In the background image determination process (S34), the main CPU 42 samples one random number value from the predetermined random number value range. Further, the main CPU 42 determines one special background image based on the sampled random number value and the set background image determination table. After determining one special background image used to generate the composite reel bands 100, the main CPU 42 shifts the process to S35.

If the process is shifted from S31 directly to S34, the main CPU 42 executes the background image determination process (S34) based on the initially set “small special background image determination table”.

The small special background image determination table and the large special background image determination table used in the background image determination process (S34) will be described in detail with reference to the drawings.

As described above, in the slot machine 1 according to the embodiment, the image ROM 86 stores plural kinds of small special background images 50. As shown in FIG. 22, in the small special background image determination table, random number value ranges are associated with respective plural kinds of small special background images 50 stored in the image ROM 86. Therefore, the main CPU 42 can identify one small special background image 50 from plural kinds of small special background images 50 based on the sampled random number value.

For example, If a random number value “333” is sampled, the main CPU 42 can determine a “small special background image (3)” as the small special background image 50 used to generate the composite reel bands 100 by referring to the small special background image determination table shown in FIG. 22.

Similarly to the small special background images 50, the image ROM 86 stores plural kinds of large special background images 55. As shown in FIG. 23, in the large special background image determination table, random number value ranges are associated with respective plural kinds of large special background images 55 stored in the image ROM 86. Therefore, the main CPU 42 can identify one large special background image from plural kinds of large special background images 55 based on the sampled random number value.

If the random number value “333” is sampled, for example, the main CPU 42 can determine a “large special background image (4)” as the large special background image 55 used to generate the composite reel bands 100 by referring to the large special background image determination table shown in FIG. 23.

In S35, the main CPU 42 executes a target reel band identification process. In the target reel band identification process (S35), the main CPU 42 identifies a plurality of target reel bands from among the symbol reel bands 90 associated with the respective reel display portions 101 through 105. At this time, the main CPU 42 identifies a plurality of the target reel band according to the size of the special background image determined in the background image determination process (S34). The “target reel band” means the symbol reel band 90 combined with the background reel band 95 including the respective partial background images related to the special background image. After identifying the target reel bands based on the size of the special background image determined in the background image determination process (S34), the main CPU 42 shifts the process to S36.

Here, a process content of the target reel band identification process (S35) will be described in detail with reference to the drawings. FIG. 24 is an explanatory diagram related to the target reel band identification process.

In the following description, the symbol reel band 90 associated with the reel display portion 101 is referred to as “first reel band”, and the symbol reel band 90 associated with the reel display portion 102 is referred to as “second reel band”. Likewise, the symbol reel bands 90 associated with the reel display portions 103 through 105 are referred to as “third reel band”, “fourth reel band”, and “fifth reel band”, respectively.

As described above, in the background image determination process (S34), the main CPU 42 determines either one small special background image 50 or one large special background image 55. Accordingly, in the target reel band identification process (S35), the process content differs between the instance of determining the “small special background image 50” in the background image determination process (S34) and the instance of determining the “large special background image 55” in the background image determination process (S34).

If the “small special background image 50” is determined in the background image determination process (S34), the main CPU 42 determines three target reel bands from among five kinds of symbol reel bands 90 associated with the reel display portions 101 through 105, respectively in the target reel band determination process (S36). Specifically, the main CPU 42 samples one random number value from the predetermined random number value range. The main CPU 42 identifies three target reel bands based on the sampled random number value and the table shown in FIG. 24. For example, if a random number value “99” is sampled, the main CPU 42 identifies the second reel band through the fourth reel band among the first reel band through the fifth reel band as the target reel bands.

As shown in FIG. 24, patterns of the target reel bands identified in this case are three patterns of “the first reel band through the third reel band”, “the second reel band through the fourth reel band”, and “the third reel band through the fifth reel band”. In these patterns, the symbol reel bands 90 associated with the three reel display portions that adjoin one another are set as the target reel bands, respectively. As described above, each target reel band is combined with the background reel band 95 including the partial background images related to the special background image. Therefore, the reel band that does not include the partial background images is not present between the target reel bands. That is, the slot machine 1 can reproduce the small special background image 50 in the variable display portion 3B by identifying the three target reel bands based on the three patterns.

On the other hand, if the “large special background image 55” is determined in the background image determination process (S34), the main CPU 42 determines all the five symbol reel bands associated with the reel display portions 101 through 105, respectively as the target reel bands in the target reel band determination process (S36). In this case, as shown in FIGS. 4, 9A and 9B, the reel band that does not include the partial background images is not naturally present between the target reel bands in view of the configuration of the reel display portions 101 through 105 and the size of the large special background image 55. That is, in this case, the slot machine 1 can reproduce the large special background image 55 in the variable display portion 3B.

After shifting to S36, the main CPU 42 executes a reel band composite process. In the reel band composite process (S36), the main CPU 42 generates the composite reel bands 100 associated with the respective reel display portions 101 through 105 by transmitting a composite reel band generation signal to the image control circuit 81. After associating all the composite reel bands 100 with the respective reel display portions 101 through 105, the main CPU 42 shifts the process to S37.

A process content of the reel band composite process (S36) will be described in more detail. After shifting to the reel band composite process (S36), the main CPU 42 transmits the composite reel band generation signal to the image control circuit 81. This composite reel band generation signal includes information indicating the special background image determined in the background image determination process (S34) and information indicating the target reel bands identified in the target reel band identification process (S35).

At this time, the main CPU 42 associates array data concerning background images of the respective background reel bands 95 based on the special background image determined in the background image determination process (S34) with the table associating the symbols and the code numbers related to the target reel bands identified in the target reel band identification process (S35). That is, the main CPU 42 generates a data table shown in FIG. 18.

Upon receiving the composite reel band generation signal, the image control CPU 82 reads the background reel band 95 based on the special background image determined in the background image determination process (S34) from the image ROM 86.

The image control CPU 82 generates the composite reel band 100 by combining the read background reel band 95 with each of the target reel bands (that is, symbol reel bands 90) identified in the target reel band identification process (S35).

More specifically, if the small special background image 50 is determined in the background image determination process (S34), the image control CPU 82 reads the first background reel band 95A through the third background reel band 95C based on the small special background image 50 from the image ROM 86 in accordance with the composite reel band generation signal received thereat.

After that, the image control CPU 82 reads the symbol reel bands 90 corresponding to the three target reel bands based on the composite reel band generation signal. The image control CPU 82 combines the first background reel band 95A through the third background reel band 95C with the three symbol reel bands 90 corresponding to the target reel bands, respectively. In other words, the image control CPU 82 generates three composite reel bands 100.

At the time of combining the background reel bands 95 with the symbol reel bands 90 corresponding to the target reel bands, the image control CPU 82 combines the first background reel band 95A with the symbol reel band 90 located at the left side (e.g., second reel band) among the three target reel bands. Likewise, the image control CPU 82 combines the second background reel band 95B with the symbol reel band 90 located at the center of the three target reel bands (e.g., third reel band). The image control CPU 82 combines the third background reel band 95C with the symbol reel band 90 located at the right side (e.g., fourth reel band) among the three target reel bands.

Furthermore, the image control CPU 82 combines the background reel band including only plain background images 57 with each of symbol reel bands 90 (e.g., first reel band and fifth reel band) other than the target reel bands.

The first reel band through the fifth reel band are associated with the reel display portions 101 through 105, respectively. Accordingly, the composite reel bands 100 generated based on the first reel band through the fifth reel band are associated with the reel display portions 101 through 105, respectively.

Accordingly, the slot machine 1 can reproduce one small special background image 50 determined in the background image determination process (S34) in the three reel display portions (e.g., the reel display portions 102 through 104) related to the target reel bands.

On the other hand, if the large special background image 55 is determined in the background image determination process (S34), the image control CPU 82 reads the first background reel band 95A through the fifth background reel band 95E based on the large special background image from the image ROM 86 in accordance with the composite reel band generation signal received thereat.

After that, the image control CPU 82 reads the symbol reel bands 90 related to the first reel band through the fifth reel band based on the composite reel band generation signal. As described above, if the large special background image 55 is determined as the special background image, all of the first reel band through the fifth reel band correspond to the target reel bands. The image control CPU 82 combines the first background reel band 95A through the fifth background reel band 95E with the five symbol reel bands 90 corresponding to the target reel bands, respectively. In other words, the image control CPU 82 generates five composite reel bands 100.

At the time of combining the background reel bands 95 with the symbol reel bands 90 corresponding to the target reel bands, the image control CPU 82 combines the first background reel band 95A with the symbol reel band 90 located at the leftmost side (i.e., first reel band) among the five target reel bands. Likewise, the image control CPU 82 combines the second background reel band 95B with the symbol reel band 90 related to the second reel band. The image control CPU 82 combines the third background reel band 95C with the symbol reel band 90 related to the third reel band. The image control CPU 82 combines the fourth background reel band 95D with the symbol reel band 90 related to the fourth reel band. The image control CPU 82 combines the fifth background reel band 95E with the symbol reel band 90 related to the fifth reel band.

The first reel band through the fifth reel band are associated with the reel display portions 101 through 105, respectively. Accordingly, the composite reel bands 100 generated based on the first reel band through the fifth reel band are associated with the reel display portions 101 through 105, respectively. Accordingly, the slot machine 1 can reproduce one large special background image 55 determined in the background image determination process (S34) in the five reel display portions (i.e., the reel display portions 101 through 105) related to the target reel bands.

If each of the composite reel bands 100 is generated based on the symbol reel band 90 and the background reel band 95 and associated with each of the reel display portions 101 through 105, the main CPU 42 terminates the reel band composite process (S36). After that, the main CPU 42 shifts the process to S37.

In S37, the main CPU 42 stores the generation-complete flag in the RAM 43 base on the termination of the generation of the composite reel bands 100 for the respective reel display portions 101 through 105 in the reel band composite process (S36). This generation-complete flag indicates that the composite reel bands 100 are generated and associated with the respective reel display portions 101 through 105. The generation-complete flag is referred to during the determination process in S31 described above. After storing the generation-complete flag in the RAM 43, the main CPU 42 terminates the composite reel generation process program.

In this case, after the composite reel band generation process (S13), the main CPU 42 executes various processes (e.g., the symbol lottery process (S14), the reel rotation control process (S15), and the payout process (S18)) based on the composite reel bands 100 generated in the composite reel band composite process (S36).

Accordingly, if the size of the special background image is changed (S33), the slot machine 1 executes a game for the slot machine 1 based on the composite reel bands 100 capable of reproducing the size-changed special background image. Likewise, if the kind of the special background image is changed (S34), the slot machine 1 executes a game for the slot machine 1 based on the composite reel bands 100 capable of reproducing the kind-changed special background image.

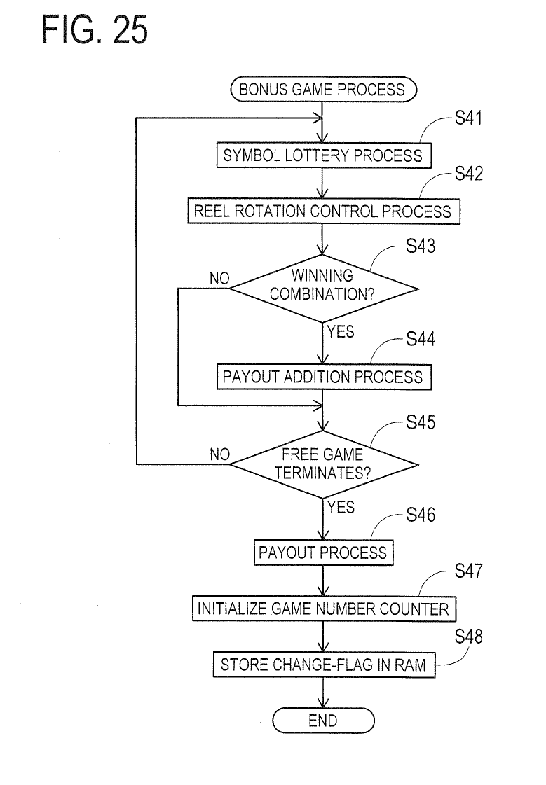

Next, the bonus game process program executed in the bonus game process (S19) will be described in detail with reference to the drawings. FIG. 25 is a flowchart of the bonus game process program.

Procedures of the free game executed in the bonus game process (S19) are basically similar to those of the normal game except that gaming values (credits) corresponding to the bet amount are not consumed at start of the game and that the game automatically continues without need for the player to operate the operation buttons.

When the execution of the bonus game process program starts, the main CPU 42 first executes a symbol lottery process (S41). When the symbol lottery process (S41) is terminated, the main CPU 42 shifts the process to a reel rotation control process (S42). After that, the main CPU 42 executes the reel rotation control process. When the reel rotation control process (S42) is terminated, the main CPU 42 shifts the process to S43.

The symbol lottery process (S41) and the reel rotation control process (S42) are same as the symbol lottery process (S14) and the reel rotation control process (S15) in the main game process program, respectively. The symbol lottery process (S41) and the reel rotation control process (S42) have already been described above, and thus, further description on the symbol lottery process (S41) and the reel rotation control process (S42) will be omitted.

After shifting to S43, the main CPU 42 judges whether or not symbols arranged in the variable display portion 3B correspond to any of winning combinations. Specifically, the main CPU 42 judges whether or not the symbols correspond to one of winning combinations based on the respective code numbers of the reel display portions 101 through 105 stored in the RAM 43 and the payout table (refer to FIG. 14). If the winning combination is established (S43: YES), the main CPU 42 shifts the process to S44. On the other hand, if any winning combinations is not established (S43: NO), the main CPU 42 shifts the process to S45.

In S44, the main CPU 42 executes a payout addition process. In the payout addition process (S44), the main CPU 42 sequentially adds the payout amount determined in S43 to payout amounts acquired during the bonus game process. The payout amount obtained as a result of addition in the payout addition process (S44) is paid out to the player in a payout process (S46) to be described later.

In S45, the main CPU 42 first adds “1” to a value of a free game counter formed in the RAM 43. After that, the main CPU 42 judges whether to satisfy a free game termination condition. That is, the main CPU 42 judges whether or not the free game has been executed by a predetermined times. If the free game is executed by the predetermined times (S45: YES), the main CPU 42 shifts the process to the payout process (S46). On the other hand, if the free game is not executed by the predetermined times (S45: NO), the main CPU 42 returns the process to the symbol lottery process (S41). As a result, the slot machine 1 executes the free game again once.

After shifting to S46, the main CPU 42 pays out the payout amount obtained as a result of the addition in the payout addition process (S44) to the player. In the payout process (S46), the payout amount including an added payout amount is paid out in a lump when a predetermined number of the free games is terminated. In this regard, the payout amount may be paid out in each of the free games. After termination of the payout process (S46), the main CPU 42 shifts the process to S47.

In S47, the main CPU 42 initializes the value of the game number counter formed in the RAM 43 to “0”. Accordingly, the value of the game number counter indicates the number of unit games executed without execution of the bonus game. After initializing the value of the game number counter, the main CPU 42 shifts the process to S48.

In S48, the main CPU 42 stores the change-flag accompanying “termination of execution of the bonus game” in the RAM 43. As described above, the slot machine 1 according to the embodiment changes the special background image used to generate the composite reel bands 100 in the composite reel band generation process (S13) because of the presence of this change-flag. After storing the change-flag in the RAM 43, the main CPU 42 terminates the bonus game process program. After that, the main CPU 42 shifts the process to S20 related to the main game process program.

As described above, the slot machine 1 according to the embodiment executes an all scatter slot game using the composite reel bands 100. Each of the composite reel bands 100 according to the embodiment is generated by combining the symbol reel bands 90 with the background reel bands 95. The respective symbol reel bands 90 is associated with each of the reel display portions 101 through 105. Then, the background reel bands 95 include the partial background images (e.g., the first partial background images 50A) based on the special background image (S13).

Therefore, the slot machine 1 can reproduce one special background image (e.g., the small special background image 50 or the large special background image 55) in the variable display portion 3B by variably displaying and stopping symbols in the respective reel display portions 101 through 105 based on the composite reel bands 100. Further, if one special background image is displayed in the variable display portion 3B (S18: YES), the slot machine 1 awards a bonus game to the player.

In this regard, the player can easily judge “whether or not one special background image is displayed” by visually recognizing the variable display portion 3B. Even the player unfamiliar with the game in the slot machine 1, the player can easily judge “whether or not one special background image is displayed in the variable display portion 3B” based on visual elements. Therefore, according to the slot machine 1, the player can easily and promptly grasp presence or absence of the bonus game by display of one special background image in the variable display portion 3B.

Moreover, in the all scatter game, the content of the prize is determined based on the number of the same kind of symbols stopped in the variable display portion 3B. Thus, according to the slot machine 1, even if the game is the all scatter game, the player can easily and promptly grasp the presence or absence of the bonus game.

In the composite reel band generation process (S13), the slot machine 1 combines the background reel band 95 including the partial background images related to one special background image with each of the target reel bands identified in the target reel band identification process (S35). As a result, the slot machine 1 can ensure displaying one special background image in the variable display portion 3B.

If the change-flag is stored in the RAM 43, the slot machine 1 newly generates composite reel bands 100 based on the special background image newly determined in the background image determination process (S34). Further, the slot machine 1 executes a game based on the newly generated composite reel bands 100. Therefore, the slot machine 1 can display various special background images in the variable display portion 3B. The slot machine 1 can diversify a display style of the variable display portion 3B. Therefore, the slot machine 1 can enhance the interest of the player.

Furthermore, the slot machine 1 changes the size of the special background image used to generate the composite reel bands 100 according to the change-flag storage condition (S33). As a result, the slot machine 1 changes the size of one special background image that can be displayed in the variable display portion 3B. That is, the slot machine 1 can enhance the interest of the player based on visual change.

Then, if the unit game is executed by the predetermined times without executing the bonus game, the slot machine 1 generates the composite reel bands 100 using the background reel bands based on the small special background image 50. In this case, the size of the special background image is small. Then, it is sufficient for the bonus game that the three reel display portions have a predetermined style (that is, a style in which the entire partial background images are displayed). That is, the slot machine 1 can increase the probability of reproducing one special background image in the variable display portion 3B.

As a result, if the unit game is executed by predetermined times without executing the bonus game, the slot machine 1 provides a game state advantageous to easy shift to the bonus game to the player. Accordingly, the slot machine 1 can enhance the interest of the player.

If the bonus game is executed, the slot machine 1 generates the composite reel bands 100 using the background reel bands 95 based on the large special background image. In this case, the size of special background image is larger than the size of the small special background image 50. That is, the player cannot execute the bonus game unless all the five reel display portions 101 through 105 have the predetermined style (that is, the style in which the entire partial background images are displayed). In other words, the slot machine 1 possibly reduces the probability of reproducing one special background image in the variable display portion 3B.

As a result, the slot machine 1 can control the player's game condition (i.e., advantage or disadvantage in the game) by switching over the special background image used to generate the composite reel bands 100 to either the small special background image 50 or the large special background image 55.

Furthermore, the slot machine 1 can further enhance the interest of the player in an advantageous game condition (i.e., during setting of the composite reel bands 100 based on the small special background image 50) by controlling the player game condition.

The present invention is not limited to the embodiment described above. Various changes and modifications of the present invention can be made without departing from the spirit and scope of the invention.

For example, in the embodiment, the small special background image 50 and the large special background image 55 (refer to FIGS. 9A and 9B) is used as the special background image. However, the special background image according to the present invention is not limited to the small special background image 50 and the large special background image 55. That is, any kind of a special background image can be used as those according to the present invention as long as the special background image is one background image corresponding to a plurality of symbol display areas that adjoin one another. For example, various sizes of the special background image can be used. Specifically, a background image of a size corresponding to the symbol display areas in a matrix of 1×3 can be used. Then, a background image of a size corresponding to the symbol display areas in a matrix of 3×4 can be used. The shape of the special background image is not limited to the matrix shape.

In the embodiment, if the bonus game trigger based on the reproduction of the special background image is achieved, the “predetermined times of free game” is awarded to the player as the bonus game. However, the present invention is not limited to the mode. That is, a content awarded as a bonus (that is, a special prize) can be variously set. For example, a “selective bonus game” can be awarded as a bonus. Then, a “payout of JACKPOT or the like” can be awarded as a bonus.

Moreover, in this case, different special prizes can be awarded to the player according to the size of the special background image. For example, if the small special background image 50 is displayed in the variable display portion 3B, the “free game” can be awarded as the bonus game similarly to the embodiment. If the large special background image is displayed in the variable display portion 3B, the “selective bonus game” can be awarded as the bonus game.

If the small special background image 50 is reproduced, a progressive jackpot having a small initial value can be paid out to the player. If the large special background image 55 is reproduced, a progressive jackpot having a large initial value can be paid out.

In the embodiment, in the reel band composite process (S36) if the small special background image 50 is determined in S34, the main CPU 42 combines background reel band 95 including only the plain background images 57 with each of symbol reel bands 90 other than the target reel bands. In this regard, the symbol reel bands 90 other than the target reel bands can be used to variably display or stop symbols in the reel display portions 101 through 105 as they are.

In the embodiment, if the bonus game is executed or the predetermined times of unit games are executed without executing the bonus game, the size and content of the special background image are changed. However, the present invention is not limited to the configuration. That is, various conditions can be adopted as conditions for changing the size and content of the special background image. For example, whenever one unit game is executed, the size and content of the special background image can be changed.

Moreover, the present invention can be realized as a gaming method to execute the processes described above. Further, the present invention can be realized as a program for causing a computer to execute the gaming method and as a recording medium on which the program is recorded.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A gaming machine comprising:
a display displaying: a plurality of symbol display areas in each of which plural kinds of symbols are variably displayed and one symbol is stopped; a plurality of reel display portions each of which is associated with a symbol column on which plural kinds of symbols are arranged, and constituted by a symbol display area; and a symbol display portion consisting of the plurality of reel display portions; and
a processor executing processes of:
(a) a process of combining a background image column on which a background image is arranged, the background image including a split background image obtained by dividing a special background image of a size corresponding to the plural symbol display areas per the symbol display area, with a symbol image column on which plural kinds of symbol images are arranged;
(b) a process of generating a composite symbol column on which a plurality of composite symbols, each consisting of a background image and a symbol image, are arranged;
(c) a process of accepting a bet of a gaming value;
(d) a process of variably displaying the plurality of symbols in the symbol display portion based on the composite symbol column;
(e) a process of stopping the plurality of symbols as a result of a game;
(f) a process of awarding an normal prize to a player according to number of symbols being stopped in the symbol display portion and having a symbol image of a same kind; and
(g) a process of awarding a special prize to the player if one special background image is constructed by a plurality of background images of the respective plurality of composite symbols stopped in the symbol display portion.

2. The gaming machine according to claim 1,
wherein the processor executes a process of changing the special background image used for generating the composite symbol column to another special background image of a size different from a size of the special background image if a predetermined condition is met.

3. A gaming machine comprising:
a display displaying: a plurality of symbol display areas in each of which plural kinds of symbols are variably displayed and one symbol is stopped; a plurality of reel display portions each of which is associated with a symbol column on which plural kinds of symbols are arranged, and constituted by a symbol display area; and a symbol display portion consisting of the plurality of reel display portions; and
a processor executing processes of:
(a) a process of combining a background image column on which a background image is arranged, the background image including a split background image obtained by dividing a special background image of a size corresponding to the plural symbol display areas per the symbol display area, with a symbol image column on which plural kinds of symbol images are arranged;
(b) a process of generating a composite symbol column on which a plurality of composite symbols, each consisting of a background image and a symbol image, are arranged;
(c) a process of identifying a plurality of reel display portions corresponding to the size of the special background image and adjoining one another;
(d) a process of associating the plurality of reel display portions which are identified; with a plurality of composite symbol columns each including a split background image corresponding to a different part of the special background image, respectively;
(e) a process of allowing the special background image to be displayed in the plurality of reel display portions currently identified;
(f) a process of accepting a bet of a gaming value;
(g) a process of variably displaying the plurality of symbols in the symbol display portion based on the composite symbol column;
(h) a process of stopping the plurality of symbols as a result of a game;
(i) a process of awarding an normal prize to a player according to number of symbols being stopped in the symbol display portion and having a symbol image of a same kind; and
(j) a process of awarding a special prize to the player if one special background image is constructed by a plurality of background images of the respective plurality of composite symbols stopped in the symbol display portion.

4. The gaming machine according to claim 3,
wherein the processor executes a process of changing the special background image used for generating the composite symbol column to another special background image of a size different from a size of the special background image if a predetermined condition is met.

5. A gaming machine comprising:
a display displaying: a plurality of symbol display areas in each of which plural kinds of symbols are variably displayed and one symbol is stopped; a plurality of reel display portions each of which is associated with a symbol column on which plural kinds of symbols are arranged, and constituted by a symbol display area; and a symbol display portion consisting of the plurality of reel display portions; and
a processor executing processes of:
(a) a process of combining a background image column on which a background image is arranged, the background image including a split background image obtained by dividing a special background image of a size corresponding to the plural symbol display areas per the symbol display area, with a symbol image column on which plural kinds of symbol images are arranged;
(b) a process of generating a composite symbol column on which a plurality of composite symbols, each consisting of a background image and a symbol image, are arranged;
(c) a process of identifying a plurality of reel display portions corresponding to the size of the special background image and adjoining one another;
(d) a process of associating the plurality of reel display portions which are identified; with a plurality of composite symbol columns each including a split background image corresponding to a different part of the special background image, respectively;
(e) a process of allowing the special background image to be displayed in the plurality of reel display portions currently identified;
(f) a process of accepting a bet of a gaming value;
(g) a process of variably displaying the plurality of symbols in the symbol display portion based on the composite symbol column;
(h) a process of stopping the plurality of symbols as a result of a game;
(i) a process of awarding an normal prize to a player according to number of symbols being stopped in the symbol display portion and having a symbol image of a same kind;
(j) a process of awarding a special prize to the player if one special background image is constructed by a plurality of background images of the respective plurality of composite symbols stopped in the symbol display portion; and
(k) a process of changing the special background image used for generating the composite symbol column to another special background image if a predetermined condition is met.

6. The gaming machine according to claim 5,
wherein the processor executes a process of changing the special background image used for generating the composite symbol column to another special background image of a size different from a size of the special background image if a predetermined condition is met.
